(19) United States
(12) Patent Application Publication
(10) Pub. No.: US 2025/0386206 A1
(43) Pub. Date: Dec. 18, 2025

(54) PREDICTIVE HYPER-LOCAL MODEL SELECTION FOR MACHINE LEARNING CHANNEL STATE FEEDBACK

(71) Applicant: QUALCOMM Incorporated, San Diego, CA (US)

(72) Inventors: Mohsen BAHRAMI, Carlsbad, CA (US); Soumya DAS, San Diego, CA (US)

(21) Appl. No.: 18/741,451

(22) Filed: Jun. 12, 2024

(51) Int. Cl. H04W 16/18; H04B 7/06; H04B 17/318

(52) U.S. Cl. CPC H04W 16/18; H04B 7/0626; H04B 7/0658; H04B 17/328

(57) ABSTRACT

Methods, systems, and devices for wireless communications are described. A user equipment (UE) may obtain a plurality of models associated with channel state feedback time domain prediction and reporting or compression and reporting, the plurality of models corresponding to respective network deployment scenarios and associated UE scenarios. The UE may obtain a coverage prediction for one or more predicted coverage zones of the UE, the coverage prediction associated with a respective cellular coverage condition for each predicted coverage zone. The UE may select a model from the plurality of models in accordance with the coverage prediction. The UE may perform channel state feedback time domain prediction and reporting or compression and reporting according to the model.

### FIELD OF TECHNOLOGY

The following relates to wireless communications, including predictive hyper-local model selection for machine learning channel state feedback.

### BACKGROUND

Wireless communications systems are widely deployed to provide various types of communication content such as voice, video, packet data, messaging, broadcast, and so on. These systems may be capable of supporting communication with multiple users by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include obtaining a set of multiple models associated with channel state feedback (CSF) time domain prediction and reporting or compression and reporting, the set of multiple models corresponding to respective network deployment scenarios and associated UE scenarios, obtaining a coverage prediction for one or more predicted coverage zones of the UE, the coverage prediction associated with a respective cellular coverage condition for each predicted coverage zone, selecting a model from the set of multiple models in accordance with the coverage prediction, and performing CSF time domain prediction and reporting or compression and reporting according to the model.

An apparatus for wireless communications at a UE is described. The apparatus may include a processing system that includes one or more processors and one or more memories coupled with the one or more processors, the processing system configured to cause the apparatus to obtain a set of multiple models associated with CSF time domain prediction and reporting or compression and reporting, the set of multiple models corresponding to respective network deployment scenarios and associated UE scenarios, obtain a coverage prediction for one or more predicted coverage zones of the UE, the coverage prediction associated with a respective cellular coverage condition for each predicted coverage zone, select a model from the set of multiple models in accordance with the coverage prediction, and perform CSF time domain prediction and reporting or compression and reporting according to the model.

Another UE for wireless communications is described. The UE may include means for obtaining a set of multiple models associated with CSF time domain prediction and reporting or compression and reporting, the set of multiple models corresponding to respective network deployment scenarios and associated UE scenarios, means for obtaining a coverage prediction for one or more predicted coverage zones of the UE, the coverage prediction associated with a respective cellular coverage condition for each predicted coverage zone, means for selecting a model from the set of multiple models in accordance with the coverage prediction, and means for performing CSF time domain prediction and reporting or compression and reporting according to the model.

A non-transitory computer-readable medium storing code for wireless communications is described. The code may include instructions executable by one or more processors to obtain a set of multiple models associated with CSF time domain prediction and reporting or compression and reporting, the set of multiple models corresponding to respective network deployment scenarios and associated UE scenarios, obtain a coverage prediction for one or more predicted coverage zones of the UE, the coverage prediction associated with a respective cellular coverage condition for each predicted coverage zone, select a model from the set of multiple models in accordance with the coverage prediction, and perform CSF time domain prediction and reporting or compression and reporting according to the model.

In some examples of the method, apparatus, user equipment (UEs), and non-transitory computer-readable medium described herein, the respective network deployment scenarios and associated UE scenarios correspond to one or more of a reference signal received power (RSRP) level, a reference signal received quality (RSRQ), a frequency division duplexing (FDD) configuration, a stand-alone (SA) configuration, a frequency band, a mobility level, an outdoor state, an indoor state, an antenna port configuration, or any combination thereof.

Some examples of the method, apparatus, user equipment (UEs), and non-transitory computer-readable medium described herein may further include operations, features, means, or instructions for obtaining an indication of a timing parameter associated with the one or more predicted coverage zones, the selecting of the model being in accordance with the timing parameter.

In some examples of the method, apparatus, user equipment (UEs), and non-transitory computer-readable medium described herein, the respective cellular coverage condition for a predicted coverage zone includes one or more of a predicted cellular coverage level, a predicted environment type, a predicted UE mobility level, a predicted reference signal received power (PRSRP), a predicted signal quality, a predicted frequency band, or a predicted network deployment scenario.

In some examples of the method, apparatus, user equipment (UEs), and non-transitory computer-readable medium described herein, the respective cellular coverage condition for a predicted coverage zone may be determined in accordance with one or more of a reference signal measurement, a radio resource control (RRC) configuration, uplink or downlink grant information, historical information, or any combination thereof.

In some examples of the method, apparatus, user equipment (UEs), and non-transitory computer-readable medium described herein, the respective cellular coverage condition for a predicted coverage zone may be determined in accordance with UE information associated with the UE or one or more other UEs.

A method for wireless communications by a UE is described. The method may include receiving a request for a UE model identifier from a network entity, the UE model identifier associated with a model from among a set of multiple models associated with CSF compression and reporting, the set of multiple models corresponding to respective network deployment scenarios and associated UE scenarios and having respective UE model identifiers, transmitting the UE model identifier in accordance with the request, the UE model identifier associated with a coverage prediction for one or more predicted coverage zones of the UE, receiving a model identifier from the network entity, the model identifier associated with the UE model identifier and a network model identifier, and performing CSF compression and reporting according to the model identifier.

An apparatus for wireless communications at a UE is described. The apparatus may include a processing system that includes one or more processors and one or more memories coupled with the one or more processors, the processing system configured to cause the apparatus to receive a request for a UE model identifier from a network entity, the UE model identifier associated with a model from among a set of multiple models associated with CSF compression and reporting, the set of multiple models corresponding to respective network deployment scenarios and associated UE scenarios and having respective UE model identifiers, transmit the UE model identifier in accordance with the request, the UE model identifier associated with a coverage prediction for one or more predicted coverage zones of the UE, receive a model identifier from the network entity, the model identifier associated with the UE model identifier and a network model identifier, and perform CSF compression and reporting according to the model identifier.

Another UE for wireless communications is described. The UE may include means for receiving a request for a UE model identifier from a network entity, the UE model identifier associated with a model from among a set of multiple models associated with CSF compression and reporting, the set of multiple models corresponding to respective network deployment scenarios and associated UE scenarios and having respective UE model identifiers, means for transmitting the UE model identifier in accordance with the request, the UE model identifier associated with a coverage prediction for one or more predicted coverage zones of the UE, means for receiving a model identifier from the network entity, the model identifier associated with the UE model identifier and a network model identifier, and means for performing CSF compression and reporting according to the model identifier.

A non-transitory computer-readable medium storing code for wireless communications is described. The code may include instructions executable by one or more processors to receive a request for a UE model identifier from a network entity, the UE model identifier associated with a model from among a set of multiple models associated with CSF compression and reporting, the set of multiple models corresponding to respective network deployment scenarios and associated UE scenarios and having respective UE model identifiers, transmit the UE model identifier in accordance with the request, the UE model identifier associated with a coverage prediction for one or more predicted coverage zones of the UE, receive a model identifier from the network entity, the model identifier associated with the UE model identifier and a network model identifier, and perform CSF compression and reporting according to the model identifier.

Some examples of the method, apparatus, user equipment (UEs), and non-transitory computer-readable medium described herein may further include operations, features, means, or instructions for obtaining the set of multiple models associated with CSF compression and reporting, obtaining the coverage prediction for the one or more predicted coverage zones of the UE, the coverage prediction associated with a respective cellular coverage condition for each predicted coverage zone, and selecting the UE model identifier in accordance with the coverage prediction.

Some examples of the method, apparatus, user equipment (UEs), and non-transitory computer-readable medium described herein may further include operations, features, means, or instructions for receiving a message identifying a UE model identifier reporting schedule for the UE, the request for the UE model identifier being in accordance with the message.

In some examples of the method, apparatus, user equipment (UEs), and non-transitory computer-readable medium described herein, the message includes at least one of an RRC message or a downlink control information (DCI) message.

In some examples of the method, apparatus, user equipment (UEs), and non-transitory computer-readable medium described herein, the respective network deployment scenarios and associated UE scenarios correspond to one or more of a reference signal received power (RSRP) level, a reference signal received quality (RSRQ), an FDD configuration, a stand-alone (SA) configuration, a frequency band, a mobility level, an outdoor state, an indoor state, an antenna port configuration, or any combination thereof.

In some examples of the method, apparatus, user equipment (UEs), and non-transitory computer-readable medium described herein, the coverage prediction may be associated with a respective cellular coverage condition for a predicted coverage zone that includes one or more of a predicted cellular coverage level, a predicted environment type, a predicted UE mobility level, a predicted reference signal received power (PRSRP), a predicted signal quality, a predicted frequency band, or a predicted network deployment scenario.

In some examples of the method, apparatus, user equipment (UEs), and non-transitory computer-readable medium described herein, the coverage prediction may be associated with a respective cellular coverage condition for each predicted coverage zone that may be determined in accordance with one or more of a reference signal measurement, an RRC configuration, uplink or downlink grant information, historical information, or any combination thereof.

Some examples of the method, apparatus, user equipment (UEs), and non-transitory computer-readable medium described herein may further include operations, features, means, or instructions for selecting a UE assistance information (UAI) framework for transmitting the UE model identifier, the transmitting of the UE model identifier being in accordance with the selected UAI framework.

In some examples of the method, apparatus, user equipment (UEs), and non-transitory computer-readable medium described herein, the UAI framework may be selected in response to a lack of configured uplink control resources for transmitting the UE model identifier.

Some examples of the method, apparatus, user equipment (UEs), and non-transitory computer-readable medium described herein may further include operations, features, means, or instructions for transmitting a UE capability message indicating support for UE model identifier reporting for CSF compression and reporting, the receiving of the request for the UE model identifier being in accordance with the UE capability message.

Some examples of the method, apparatus, user equipment (UEs), and non-transitory computer-readable medium described herein may further include operations, features, means, or instructions for receiving a configuration for uplink control resources, the transmitting of the UE model identifier being via the uplink control resources.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports predictive hyper-local model selection for machine learning (ML) channel state feedback (CSF).

FIG. 2 shows an example of a wireless communications system that illustrates a model management entity and ML CSF scenario prediction entity of a user equipment (UE) that supports predictive hyper-local model selection for ML CSF.

FIG. 3 shows an example of a prediction model that illustrates signaling between a model management entity and ML CSF scenario prediction entity of a UE that that supports predictive hyper-local model selection for ML CSF.

FIG. 4 shows an example of a swim diagram that illustrates a network-configured uplink control resource selection for ML CSF reporting and that supports predictive hyper-local model selection for ML CSF.

FIG. 5 shows an example of a swim diagram that illustrates a UE assistance information (UAI) framework that supports predictive hyper-local model selection for machine learning CSF.

FIGS. 6 and 7 show block diagrams of devices that illustrates predictive model selection for ML CSF time domain prediction with UE-sided models and cooperative mode selection for ML CSF compression with two-sided models that support predictive hyper-local model selection for ML CSF.

FIG. 8 shows a block diagram of a communications manager that illustrates predictive model selection for ML CSF time domain prediction with UE-sided models and cooperative mode selection for ML CSF compression with two-sided models and that supports predictive hyper-local model selection for ML CSF.

FIG. 9 shows a diagram of a system including a device that illustrates predictive model selection for ML CSF time domain prediction with UE-sided models and cooperative mode selection for ML CSF compression with two-sided models and that supports predictive hyper-local model selection for ML CSF.

FIGS. 10 through 13 show flowcharts illustrating methods that illustrates predictive model selection for ML CSF time domain prediction with UE-sided models and cooperative mode selection for ML CSF compression with two-sided models and that support predictive hyper-local model selection for ML CSF.

### DETAILED DESCRIPTION

Due to the nature of the wireless channel medium and wide range of deployment scenarios in cellular communications, the distribution of channel conditions may change drastically when a user equipment (UE) is moving. Accordingly, some wireless networks may use machine learning techniques to optimize network performance. For example, wireless networks may use universal machine learning modeling for channel state feedback (CSF) compression and reporting to try to optimize the CSF accuracy and performance.

In non-compressed scenarios, CSF generally includes a UE collecting and providing various parameters or metrics regarding the channel performance or conditions. Increased amounts of information collected and reported generally improves channel performance evaluation and related scheduling or configuration decisions in the wireless network. However, utilization of such techniques may be associated with a large amount of channel measurements and the associated reporting.

Compressed CSF techniques use a larger dataset of such parameters or metrics and generate a matrix (e.g., a spatial compression matrix, a frequency compression matrix, or other matrix) that is used to compress or otherwise reduce the amount of CSF data being provided. However, the universal model trained on data collected from various channel conditions, network deployments, and UE scenarios may be unable to achieve optimal accuracy (e.g., due to the limited sampling size).

Accordingly, in some examples hyper-local machine learning models may be used to develop scenario-specific CSF models that are switched depending on the deployment scenario and underlying UE situation. For example, a set of hyper-local models for machine learning CSF time-domain predictions are trained and stored offline for different UE and network scenarios. Examples of such model include, but are not limited to, a model for a poor reference signal receive power (RSRP) scenario, a poor reference signal received quality (RSRQ) scenario, a frequency division duplexing (FDD) scenario, a stationary or parked UE scenario, a high UE mobility scenario, or models covering other scenarios.

Such a switching approach, however, depends on detecting the accurate switching points between the scenario-specific CSF models and ensuring that both the UE and the network entity are using the same CSF model for channel performance estimation. That is, this approach uses two-sided models for CSF compression (e.g., a machine learning-based encoder at the UE and a machine learning-based decoder at the network entity) that use coordination between the UE and network entity to ensure compatibility between the CSF compression models being used by both devices. For example, such techniques may not adapt quickly to various changing channel conditions, which may result in a disconnect between the models being used by the UE and the network entity or, in some cases, the wrong models being used (e.g., models covering a different scenario than the one the UE is currently experiencing).

Aspects of the techniques described herein provide for various techniques to improve machine-learning (ML) CSF modeling. In particular, the described techniques may enhancements for predictive model selection to improve ML CSF accuracy and performance using hyper-local (HL) models for UE. Predictive model selection techniques may use various inputs (e.g., such as the configured throughput and a projected throughput for a zone) to select the optimal utility or model for the next predicted zone or coverage area of the UE. The configured throughput may be based on the bandwidth, the number of component carriers, the number of layers, or other (pre) configured information for a predicted zone or coverage area of the UE. The predicted throughput may be based on various scaling metrics (e.g., scaled based on the channel quality within the zone), network loading, or other cost-related features for the predicted zone or coverage area of the UE. Such techniques may consider or otherwise apply data aging determination to ensure the predicted zone or coverage area of the UE is most accurately depicted. Examples of such predictive techniques are described in U.S. patent application Ser. No. 18/416,859, which is incorporated by reference in its entirety herein.

For example, a UE may receive or otherwise obtain a plurality of models (such as HL models) associated with CSF time domain prediction and reporting. Each model may generally correspond to a network deployment scenario and the associated UE scenario. The UE may receive or otherwise obtain a coverage prediction for predicted coverage zone(s) of the UE. The coverage prediction may generally define a predicted cellular coverage and condition for the respective coverage zone. The UE may (such as autonomously) select a model from the plurality of models based on the coverage prediction and perform CSF time domain prediction and reporting or compression and reporting according to the model.

Additionally, or alternatively, the UE may receive a request for a UE model identifier from a network entity. The UE model identifier may be associated with a model from a plurality of models associated with CSF compression and reporting. The UE may transmit the UE model identifier based on the coverage prediction for the predicted coverage zone(s) of the UE. The network may use the UE model identifier and a network model identifier to determine a model identifier that is transmitted to the UE. The UE may perform the CSF compression and reporting according to the model identifier.

Accordingly, the techniques described herein provide for enhancements for selecting the most suitable HL model for CSF time-domain prediction in mobile UEs (such as vehicular UEs) based on the predicted cell coverage information, predicted UE environment and predilected UE mobility level (such as for a given UE/vehicle route), among other potential benefits. Improved UE-network signaling enhancements and a cooperative mechanism for CSF compression (encoder/decoder) selection are also described. This may include UAI enhancements and solutions for a UE to indicate and determine the preferred (such as within the proposed cooperative scheme for ML CSF compression encoder/decoder model selection) model, among other enhancements.

Aspects of the disclosure are initially described in the context of wireless communications systems. Aspects of the disclosure are further illustrated by and described with reference to apparatus diagrams, system diagrams, and flowcharts that relate to predictive hyper-local model selection for machine learning CSF.

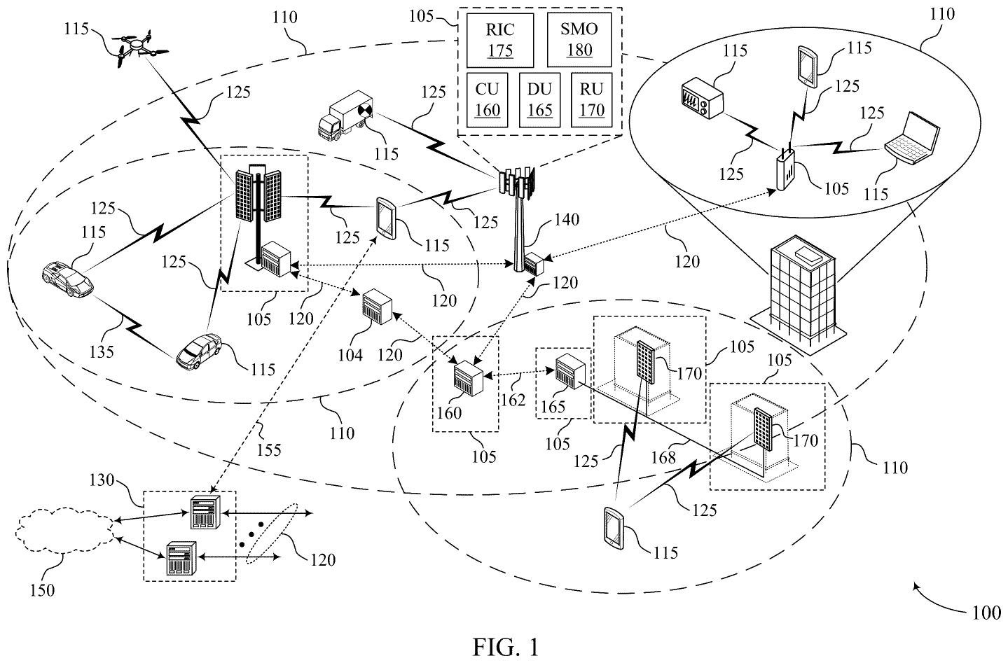

FIG. 1 shows an example of a wireless communications system 100 that supports predictive hyper-local model selection for machine learning CSF. The wireless communications system 100 may include one or more devices, such as one or more network devices (such as network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (such as a radio frequency (RF) access link). For example, a network entity 105 may support a coverage area 110 (such as a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (such as other wireless communication devices, including UEs 115 or network entities 105), as shown in FIG. 1.

As described herein, a node of the wireless communications system 100, which may be referred to as a network node, or a wireless node, may be a network entity 105 (such as any network entity described herein), a UE 115 (such as any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (such as in accordance with an S1, N2, N3, or other interface protocol). In some examples, network entities 105 may communicate with one another via backhaul communication link(s) 120 (such as in accordance with an X2, Xn, or other interface protocol) either directly (such as directly between network entities 105) or indirectly (such as via the core network 130). In some examples, network entities 105 may communicate with one another via a midhaul communication link 162 (such as in accordance with a midhaul interface protocol) or a fronthaul communication link 168 (such as in accordance with a fronthaul interface protocol), or any combination thereof. The backhaul communication link(s) 120, midhaul communication links 162, or fronthaul communication links 168 may be or include one or more wired links (such as an electrical link, an optical fiber link) or one or more wireless links (such as a radio link, a wireless optical link), among other examples or various combinations thereof. A UE 115 may communicate with the core network 130 via a communication link 155.

One or more of the network entities 105 or network equipment described herein may include or may be referred to as a base station 140 (such as a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (such as a base station 140) may be implemented in an aggregated (such as monolithic, standalone) base station architecture, which may be configured to utilize a protocol stack that is physically or logically integrated within one network entity (such as a network entity 105 or a single RAN node, such as a base station 140).

In some examples, a network entity 105 may be implemented in a disaggregated architecture (such as a disaggregated base station architecture, a disaggregated RAN architecture), which may be configured to utilize a protocol stack that is physically or logically distributed among multiple network entities (such as network entities 105), such as an integrated access and backhaul (IAB) network, an open RAN (O-RAN) (such as a network configuration sponsored by the O-RAN Alliance), or a virtualized RAN (vRAN) (such as a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (such as a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (such as separate physical locations). In some examples, one or more of the network entities 105 of a disaggregated RAN architecture may be implemented as virtual units (such as a virtual CU (VCU), a virtual DU (VDU), a virtual RU (VRU)).

The split of functionality between a CU 160, a DU 165, and an RU 170 is flexible and may support different functionalities depending on which functions (such as network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (such as layer 3 (L3), layer 2 (L2)) functionality and signaling (such as Radio Resource Control (RRC), service data adaptation protocol (SDAP), Packet Data Convergence Protocol (PDCP)). The CU 160 (such as one or more CUs) may be connected to a DU 165 (such as one or more DUs) or an RU 170 (such as one or more RUs), or some combination thereof, and the DUs 165, RUs 170, or both may host lower protocol layers, such as layer 1 (L1) (such as physical (PHY) layer) or L2 (such as radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (such as via one or multiple different RUs, such as an RU 170). In some cases, a functional split between a CU 160 and a DU 165 or between a DU 165 and an RU 170 may be within a protocol layer (such as some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (such as F1, F1-c, F1-u), and a DU 165 may be connected to an RU 170 via a fronthaul communication link 168 (such as open fronthaul (FH) interface). In some examples, a midhaul communication link 162 or a fronthaul communication link 168 may be implemented in accordance with an interface (such as a channel) between layers of a protocol stack supported by respective network entities (such as one or more of the network entities 105) that are in communication via such communication links.

In some wireless communications systems (such as the wireless communications system 100), infrastructure and spectral resources for radio access may support wireless backhaul link capabilities to supplement wired backhaul connections, providing an IAB network architecture (such as to a core network 130). In some cases, in an IAB network, one or more of the network entities 105 (such as network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (such as IAB donors) may be in communication with one or more additional devices (such as IAB node(s) 104) via supported access and backhaul links (such as backhaul communication link(s) 120). IAB node(s) 104 may include an IAB mobile termination (IAB-MT) controlled (such as scheduled) by one or more DUs (such as DUs 165) of a coupled IAB donor. An IAB-MT may be equipped with an independent set of antennas for relay of communications with UEs 115 or may share the same antennas (such as of an RU 170) of IAB node(s) 104 used for access via the DU 165 of the IAB node(s) 104 (such as referred to as virtual IAB-MT (vIAB-MT)). In some examples, the IAB node(s) 104 may include one or more DUs (such as DUs 165) that support communication links with additional entities (such as IAB node(s) 104, UEs 115) within the relay chain or configuration of the access network (such as downstream). In such cases, one or more components of the disaggregated RAN architecture (such as the IAB node(s) 104 or components of the IAB node(s) 104) may be configured to operate according to the techniques described herein.

For instance, an access network (AN) or RAN may include communications between access nodes (such as an IAB donor), IAB node(s) 104, and one or more UEs 115. The IAB donor may facilitate connection between the core network 130 and the AN (such as via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (such as a backhaul link). The IAB donor and IAB node(s) 104 may communicate via an F1 interface according to a protocol that defines signaling messages (such as an F1 AP protocol). Additionally, or alternatively, the CU 160 may communicate with the core network 130 via an interface, which may be an example of a portion of a backhaul link, and may communicate with other CUs (such as including a CU 160 associated with an alternative IAB donor) via an Xn-C interface, which may be an example of another portion of a backhaul link.

IAB node(s) 104 may refer to RAN nodes that provide IAB functionality (such as access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (such as an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (such as the IAB node(s) 104) to receive signaling from a parent IAB node (such as the IAB node(s) 104), and a DU interface (such as a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (such as backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (such as transmissions to the UEs 115 relayed from the IAB donor) through one or more DUs (such as DUs 165). That is, data may be relayed to and from IAB node(s) 104 via signaling via an NR Uu interface to MT of IAB node(s) 104 (such as other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (such as a base station 140) may additionally, or alternatively, be performed by one or more components of the disaggregated RAN architecture (such as components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (such as one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (such as a bandwidth part (BWP)) that is operated according to one or more PHY layer channels for a given RAT (such as LTE, LTE-A, LTE-A Pro, NR). Each PHY layer channel may carry acquisition signaling (such as synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (such as entity, sub-entity) of a network entity 105. For example, the terms “transmitting,” “receiving,” or “communicating,” when referring to a network entity 105, may refer to any portion of a network entity 105 (such as a base station 140, a CU 160, a DU 165, a RU 170) of a RAN communicating with another device (such as directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (such as an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (such as of the same or a different RAT).

The communication link(s) 125 of the wireless communications system 100 may include downlink transmissions (such as forward link transmissions) from a network entity 105 to a UE 115, uplink transmissions (such as return link transmissions) from a UE 115 to a network entity 105, or both, among other configurations of transmissions. Carriers may carry downlink or uplink communications (such as in an FDD mode) or may be configured to carry downlink and uplink communications (such as in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (such as 1.4, 3, 5, 10, 15, 20, 40, or 80 megahertz (MHz)). Devices of the wireless communications system 100 (such as the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (such as a sub-band, a BWP) or all of a carrier bandwidth.

Signal waveforms transmitted via a carrier may be made up of multiple subcarriers (such as using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (such as a duration of one modulation symbol) and one subcarrier, in which case the symbol period and subcarrier spacing may be inversely related. The quantity of bits carried by each resource element may depend on the modulation scheme (such as the order of the modulation scheme, the coding rate of the modulation scheme, or both), such that a relatively higher quantity of resource elements (such as in a transmission duration) and a relatively higher order of a modulation scheme may correspond to a relatively higher rate of communication. A wireless communications resource may refer to a combination of an RF spectrum resource, a time resource, and a spatial resource (such as a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (such as 10 milliseconds (ms)). Each radio frame may be identified by a system frame number (SFN) (such as ranging from 0 to 1023).

Each frame may include multiple consecutively-numbered subframes or slots, and each subframe or slot may have the same duration. In some examples, a frame may be divided (such as in the time domain) into subframes, and each subframe may be further divided into a quantity of slots. Alternatively, each frame may include a variable quantity of slots, and the quantity of slots may depend on subcarrier spacing. Each slot may include a quantity of symbol periods (such as depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (such as N_{f}) sampling periods. The duration of a symbol period may depend on the subcarrier spacing or frequency band of operation.

A subframe, a slot, a mini-slot, or a symbol may be the smallest scheduling unit (such as in the time domain) of the wireless communications system 100 and may be referred to as a transmission time interval (TTI). In some examples, the TTI duration (such as a quantity of symbol periods in a TTI) may be variable. Additionally, or alternatively, the smallest scheduling unit of the wireless communications system 100 may be dynamically selected (such as in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (such as a control resource set (CORESET)) for a physical control channel may be defined by a set of symbol periods and may extend across the system bandwidth or a subset of the system bandwidth of the carrier. One or more control regions (such as CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (such as control channel elements (CCEs)) associated with encoded information for a control information format having a given payload size. Search space sets may include common search space sets configured for sending control information to UEs 115 (such as one or more UEs) or may include UE-specific search space sets for sending control information to a UE 115 (such as a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (such as using a carrier) and may be associated with an identifier for distinguishing neighboring cells (such as a physical cell identifier (PCID), a virtual cell identifier (VCID)). In some examples, a cell also may refer to a coverage area 110 or a portion of a coverage area 110 (such as a sector) over which the logical communication entity operates. Such cells may range from smaller areas (such as a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (such as several kilometers in radius) and may allow unrestricted access by the UEs 115 with service subscriptions with the network provider supporting the macro cell. A small cell may be associated with a network entity 105 operating with lower power (such as a base station 140 operating with lower power) relative to a macro cell, and a small cell may operate using the same or different (such as licensed, unlicensed) frequency bands as macro cells. Small cells may provide unrestricted access to the UEs 115 with service subscriptions with the network provider or may provide restricted access to the UEs 115 having an association with the small cell (such as the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (such as MTC, narrowband IoT (NB-IoT), enhanced mobile broadband (eMBB)) that may provide access for different types of devices.

In some examples, a network entity 105 (such as a base station 140, an RU 170) may be movable and therefore provide communication coverage for a moving coverage area, such as the coverage area 110. In some examples, coverage areas 110 (such as different coverage areas) associated with different technologies may overlap, but the coverage areas 110 (such as different coverage areas) may be supported by the same network entity (such as a network entity 105). In some other examples, overlapping coverage areas, such as a coverage area 110, associated with different technologies may be supported by different network entities (such as the network entities 105). The wireless communications system 100 may include, for example, a heterogeneous network in which different types of the network entities 105 support communications for coverage areas 110 (such as different coverage areas) using the same or different RATs.

The wireless communications system 100 may support synchronous or asynchronous operation. For synchronous operation, network entities 105 (such as base stations 140) may have similar frame timings, and transmissions from different network entities (such as different ones of the network entities 105) may be approximately aligned in time. For asynchronous operation, network entities 105 may have different frame timings, and transmissions from different network entities (such as different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (such as via Machine-to-Machine (M2M) communication). M2M communication or MTC may refer to data communication technologies that allow devices to communicate with one another or a network entity 105 (such as a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (such as a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (such as according to narrowband communications), or a combination of these techniques. For example, some UEs 115 may be configured for operation using a narrowband protocol type that is associated with a defined portion or range (such as set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (such as one or more of the UEs 115) via a device-to-device (D2D) communication link, such as a D2D communication link 135 (such as in accordance with a peer-to-peer (P2P), D2D, or sidelink protocol). In some examples, one or more UEs 115 of a group that are performing D2D communications may be within the coverage area 110 of a network entity 105 (such as a base station 140, an RU 170), which may support aspects of such D2D communications being configured by (such as scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (such as UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (such as network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (such as a mobility management entity (MME), an access and mobility management function (AMF)) and at least one user plane entity that routes packets or interconnects to external networks (such as a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (such as base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (such as less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (such as from 30 GHz to 300 GHz), also known as the millimeter band. In some examples, the wireless communications system 100 may support millimeter wave (mmW) communications between the UEs 115 and the network entities 105 (such as base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (such as LAA). Operations using unlicensed spectrum may include downlink transmissions, uplink transmissions, P2P transmissions, or D2D transmissions, among other examples.

A network entity 105 (such as a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (such as the same codeword) or different data streams (such as different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (such as a network entity 105, a UE 115) to shape or steer an antenna beam (such as a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (such as with respect to the antenna array of the transmitting device or receiving device, or with respect to some other orientation).

A network entity 105 or a UE 115 may use beam sweeping techniques as part of beamforming operations. For example, a network entity 105 (such as a base station 140, an RU 170) may use multiple antennas or antenna arrays (such as antenna panels) to conduct beamforming operations for directional communications with a UE 115. Some signals (such as synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (such as by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (such as a network entity 105 or a UE 115) along a single beam direction (such as a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (such as by a network entity 105 or a UE 115) may be performed using multiple beam directions, and the device may use a combination of digital precoding or beamforming to generate a combined beam for transmission (such as from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (such as a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (such as a multi-panel type codebook, a linear combination type codebook, a port selection type codebook). Although these techniques are described with reference to signals transmitted along one or more directions by a network entity 105 (such as a base station 140, an RU 170), a UE 115 may employ similar techniques for transmitting signals multiple times along different directions (such as for identifying a beam direction for subsequent transmission or reception by the UE 115) or for transmitting a signal along a single direction (such as for transmitting data to a receiving device).

A receiving device (such as a UE 115) may perform reception operations in accordance with multiple receive configurations (such as directional listening) when receiving various signals from a transmitting device (such as a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (such as different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (such as when receiving a data signal). The single receive configuration may be aligned along a beam direction determined based on listening according to different receive configuration directions (such as a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (such as the communication link(s) 125, a D2D communication link 135). HARQ may include a combination of error detection (such as using a cyclic redundancy check (CRC)), forward error correction (FEC), and retransmission (such as automatic repeat request (ARQ)). HARQ may improve throughput at the MAC layer in relatively poor radio conditions (such as low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may obtain a plurality of models associated with CSF time domain prediction and reporting or compression and reporting, the plurality of models corresponding to respective network deployment scenarios and associated UE scenarios. The UE 115 may obtain the coverage prediction for the one or more predicted coverage zones of the UE, the coverage prediction associated with a respective cellular coverage condition for each predicted coverage zone. The UE 115 may select a model from the plurality of models in accordance with the coverage prediction. The UE 115 may perform CSF time domain prediction and reporting or compression and reporting according to the model.

A UE 115 may receive a request for a UE model identifier from a network entity, the UE model identifier associated with a model from among a plurality of models associated with CSF compression and reporting, the plurality of models corresponding to respective network deployment scenarios and associated UE scenarios and having respective UE model identifiers. The UE 115 may transmit the UE model identifier in accordance with the request, the UE model identifier associated with a coverage prediction for one or more predicted coverage zones of the UE 115. The UE 115 may receive a model identifier from the network entity, the model identifier associated with the UE model identifier and a network model identifier. The UE 115 may perform CSF compression and reporting according to the model identifier.

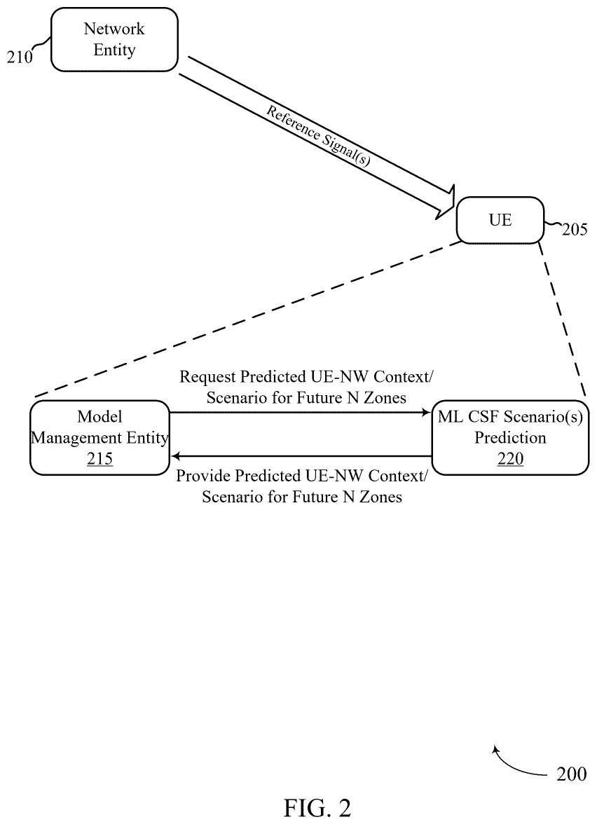

FIG. 2 shows an example of a wireless communications system 200 that supports predictive hyper-local model selection for machine learning CSF. Wireless communications system 200 may implement aspects of wireless communications system 100. Wireless communications system 200 may include a UE 205 and a network entity 210, which may be examples of the corresponding devices described herein.

Wireless networks may use machine learning or non-machine learning algorithms to improve network performance. One example may include the encoding/decoding operations of the UE and the network entity that are based on downlink channel estimates. For example, a nominal or reference encoder function may be implemented at or by the UE while a nominal or reference decoder function may be implemented at or by the network entity. The UE encoder may measure or otherwise obtain channel metrics (such as downlink channel measurements or estimates) that are provided to or otherwise used by the encoder for encoding data for transmission to the network entity (such as via a data or control channel). The output of the UE encoder is transmitted using the wireless medium to the network entity and input into the network decoder. By way of non-limiting example, the UE encoder output may be a compressed CSF, which is input into the network decoder. The compressed CSF may broadly include a quantity of channel measurements or other performance metrics that are compressed by the UE encoder. The network decoder outputs a reconstructed CSF, such as using precoding vector(s), channel vector(s), or other precoding related information. In such cross-node machine learning techniques, the neural network is split into two portions (such as the encoder of the UE and the decoder of the network entity).

In some examples, this training of the UE encoder/network decoder may be performed offline using servers associated with the UE and network. For example, in multi-vendor training scenarios each vendor (such as the UE vendor and the network entity vendor) may have its own server that participates in the offline training. For example, the UE server may be associated with a vender of the UE 205 and the network server may be associated with the network entity 210. The UE vender server(s) may communicate with the network server(s) during the training using server-to-server connections. For example, the UE server and the network server may exchange various training dataset(s) associated with the UE 205 and the network entity 210 during the training process.

Different training cases may be used for such multi-vendor training procedures. A first case may be a type 3 training that is performed between one network part model (such as the network decoder) and one UE part model (such as the UE encoder). A second case may be a UE-first training techniques where type 3 training is performed between one network part model and N>1 UE part models. A third case may be a network-first training where type 3 training is performed between one UE part model and N>1 network part models.

In some aspects, the training scheme may include a sequential training that is driven be the network entity. In some training models, the specific machine learning training model may be the same between the UE encoder and the network decoder, which may include the devices sharing model information and parameters. In multi-vendor training models, this approach may mean that each network vendor would share their modeling related information with the other network vendor. In sequential training, this scheme enables the UE 205 and the network entity 210 to keep their training models private (such as each vendor is unaware which model(s) the other vendors are using). This approach differs from the one-sided concurrent training techniques discussed above.

For example, in the network-first sequential training approach the network decoder (such as a network-based decoder) may be trained first at the network server with an encoder that is chosen or otherwise selected by the network entity 210. This may include a network-based auto-encoder being implemented at the network entity 210, at the network server, or both. The network-based auto-encoder may include a network-based encoder and a network-based decoder that are used to train the decoder of the network entity 210.

More particularly, network-based auto-encoder may operate by inputting channel metrics or precoding metrics (Vin or simply V) estimated or otherwise associated with the channel. The output of the network-based encoder may include a compressed CSF information (such as precoding vectors or channel vectors, which may be referred to as z) that is provided to a loss function for evaluation of the training iteration. The loss function evaluation evaluates the accuracy of the network-based decoder in view of the channel metrics input to the network-based encoder. For example, the output of the loss function may update various weights or other parameters of the network-based encoder, the network-based decoder, or both, to improve the training output (such as to provide more accurate z). In the network-driven sequential training scenario, the network server may transmit or otherwise provide the output of the network-based decoder portion of the network-based auto-encoder (such as z) along with the training inputs (such as V) to the UE server. The UE server may use (z, V) as a training input dataset to train the encoder of the UE 205, which results in the encoder of the UE 205 being trained to the decoder of the network entity 210.

To avoid model information being shared, some training techniques may include one-sided models where the network entity indicates some criteria (such as such as the time, zone, cell, and other criteria) where the UE 205 is to collect data (such as measure reference signals or otherwise obtain channel metrics). The “model” being used by the network entity may be identified based on either the criteria indicated to the UE 205 or based on an identifier (such as a dataset identifier). The UE 205 may train a model (such as the UE encoder) using this collected data (such as the channel metrics). Although the network knows the network-side settings applicable to the model, this information is not revealed to the UE 205 and the network may use this trained model during inference operations with respect to the UE (such as for power aware scheduling).

Accordingly, such machine-learning CSF techniques may be used to create various models that correspond to or otherwise relate to network deployment scenarios as well as the corresponding UE deployment scenarios. However, due to the wireless nature of the channel medium and a wide range of deployment scenarios in the cellular communications network, the distribution of channel conditions can change drastically due to UE mobility (such as such as vehicle UEs which have highly dominant mode of operations). In the case of the machine-learning CSF, it is possible that a universal model trained on data collected from various channel conditions, network deployments, and UE scenarios may not achieve the optimal accuracy performance in certain situations. That is, to achieve sufficient feedback recovery with a universal mode, massive CSI samples would be required from multiple different scenarios. This approach may require extensive resources and consume considerable time.

Accordingly, scenario-specific machine-learning (ML) CSF models may be trained and used (such as hyper-local (HL) models) to address this issue. For example, the UE 205 and the network entity 210 may then rely on switching the localized models based on the detected network and UE deployment scenarios as well as the underlaying UE situation (such as the UE scenario). In some aspects, these models may use artificial intelligence (AI) or ML techniques for the air interface for two-sided ML CSF compression. However, a remaining challenge to ensure the accuracy performance may be to determine the switching points in a timely manner when the UE 205 moves and how the coordination between the UE 205 and the network entity 210 can be established. In ML CSF, due to two-sided models for CSF compression (such as involving ML-based encoder at the UE 205 and ML-based decoder at the network entity 210), this may be coordinated between the UE 205 and the network entity 210 to ensure compatibility between the CSF compression model at the UE 205 and the CSI reconstruction model at the network entity 210.

Accordingly, aspects of the techniques described herein provide for UE implementation enhancements for predictive model selection to improve the ML CSF accuracy performance using hyper-local modes (such as in vehicular UEs). Aspects of the techniques described herein generally provide for predictive model selection for ML CSF time domain prediction with UE-sided models. Additionally, or alternatively, aspects of the techniques described herein generally provide for cooperative model selection for ML CSF compression with two-sided models. For the cooperative HL model selection for ML CSF compression, aspects of the described techniques may include signaling enhancements that expand uplink control signaling and UE assistance information (UAI) frameworks.

For example, the UE 205 may receive or otherwise obtain a plurality of models associated with CSF time domain prediction and reporting or compression and reporting. The plurality of models may generally include models that correspond to respective network deployment scenarios and associated UE scenarios. For example, a set of HL models for ML CSF time domain prediction for different UE and network scenarios may be trained offline and stored at the UE 205. That may be specific HL models for such UE/network scenarios as poor RSRP, poor RSRQ, FDD, stand-alone (SA), low band frequency, stationary UE/parked vehicle, indoor cell deployments (such as with 32 transmit CSI-RS antenna ports at the gNB), among others. That is, the respective network deployment scenarios and associated UE scenarios may include one or multiple of an RSRP, an RSRQ, an FDD configuration, an SA configuration, a frequency band, a mobility level, an outdoor state, an indoor state, an antenna port configuration, among other scenarios.

Accordingly, the UE 205 may receive or otherwise obtain a coverage prediction for one or more predicted coverage zones of the UE 205. The coverage prediction may be for or otherwise associated with a respective cellular coverage condition for each predicted coverage zone. The UE 205 may identify or otherwise select a model from the plurality of models in accordance with the coverage prediction.

In some aspects, the respective cellular coverage condition for each predicted coverage zone may include one or more of a predicted cellular coverage level, a predicted environment type, a predicted UE mobility level, a predicted RSRP, a predicted signal quality, a predicted frequency band, a predicted network deployment scenario, or any other predicted aspects of the cellular coverage or performance within the predicted zone. The respective cellular coverage condition for the predicted zone may be identified or otherwise determined based on reference signal measurements, a RRC configuration, uplink or downlink grant information, or historical information. The respective cellular coverage condition for the predicted zone may be identified or otherwise determined based on UE information (such as information that the UE 205 determines) or based on information from other UE(s) (such as information that have been reported by other UE(s)).

For example, this may include the UE 205 predicting the most suitable HL model(s) within a future (such as (pre) configured) segment (such as zone) of the UE's route (such as future zones that the UE 205 expects to enter/pass through) based on predicted cellular coverage information, the predicted environment type, and the predicted UE mobility level within the predicted UE trajectory/path. The cellular coverage prediction information may include or otherwise be based on the signal strength (such as RSRP), the signal quality (such as RSRS or signal-to-interference noise ratio (SINR)), the frequency range (such as sub-6 GHz, low-band, mid-band, or high-band frequencies, mmW) and the inferred network deployment type (such as SA/non-SA (NSA), TDD/FDD, or other information such as the transmit antenna configuration of the network entity 210). The UE 205 may predict the cellular coverage information based on the current or past UE reference signal measurements, based on RRC configuration(s) and downlink or uplink grant information for the current and previous zones as well as the history of such information from the modem cell history database. Additionally, or alternatively, the UE 205 may pull this information from crowdsources information from a cloud service (such as such as car-to-car (C2C)) for the future zones within the predicted UE trajectory or path.

The UE 205 may predict the UE mobility level (such as parked, low mobility, normal mobility, high mobility) and the environment type (such as a parking garage) in the future zones based on a combination of mapping information, UE/vehicle user trip information, as well as other UE/vehicle sensor information, such as location, speed, and heading (such as based on GNSS and IMU). Once the predicted UE/network scenario in the current and all future zones indicate a preferred UE/network scenario that was previously considered (such as modeled), the model management entity 215 may use the corresponding HL model for ML CSF time domain prediction. For example, the prediction entity 220 of the UE 205 may select the model from the plurality of models in accordance with the coverage prediction and the UE 205 may perform CSF timing domain prediction and reporting according to the model. That is, the model management entity 215 of the UE 205 may exchange message(s) with the prediction entity 220 requesting and providing the predicted UE-network context/scenario information for the future N zones to identify or otherwise determine the coverage prediction for the predicted coverage zones for model selection.

In some aspects, the time domain corresponding to the predicted (such as future) coverage zones may be (pre) configured for the UE 205. For example, the UE 205 may receive or otherwise obtain an indication of a timing parameter associated with the predicted coverage zones. The timing parameter may generally correspond to how far into the future that the UE 205 is to predict the future N zones that the UE 205 will enter, be located within, or pass though. The UE 205 may use the timing parameter to select the appropriate model(s) accordingly.

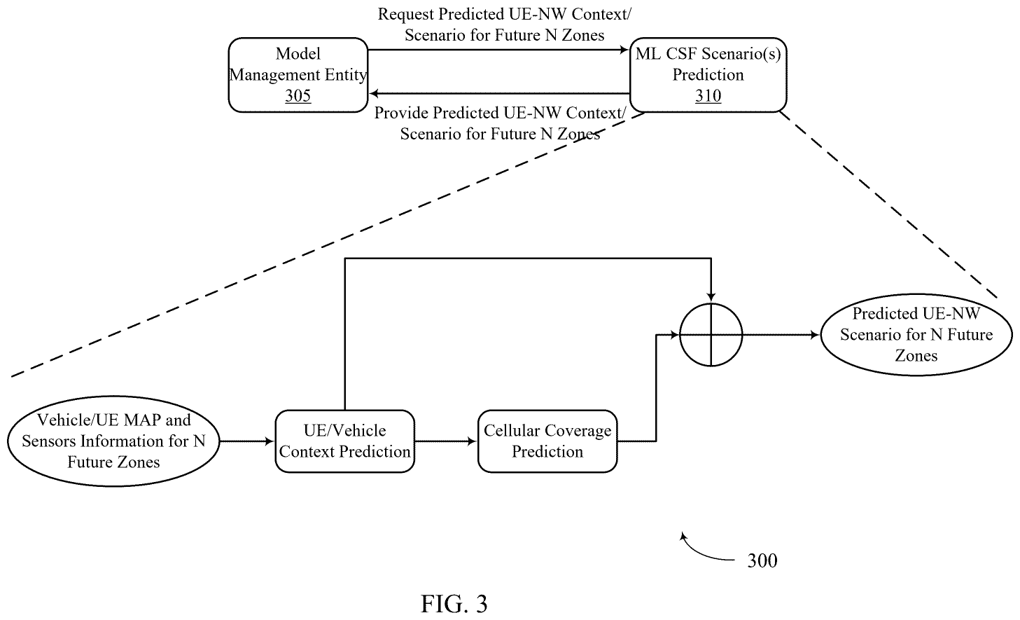

FIG. 3 shows an example of a prediction model 300 that supports predictive hyper-local model selection for machine learning CSF. Prediction model 300 may implement aspects of wireless communications system 100 or wireless communications system 200. Aspects of prediction model 300 may be implemented at or implemented by a UE, which may be an example of the corresponding device described herein. For example, the UE may be equipped with or otherwise support a model management entity 305 and a prediction entity 310.

As discussed above, the techniques described herein provide for a UE to receive or otherwise obtain a plurality of models (such as HL ML CSF models) that are associated with one or both of CSF time domain prediction and reporting or CSF compression and reporting. The UE may receive, identify, or otherwise obtain a coverage prediction for predicted coverage zones(s) of the UE. The coverage prediction may be associated with a respective cellular coverage condition for each predicted coverage zone. The UE may identify or otherwise select a model from the plurality of models in accordance with the coverage prediction and perform CSF time domain prediction and reporting or compression and reporting according to the model.

Prediction model 300 illustrates one non-limiting example of the coverage prediction and model selection techniques described herein. Broadly, this may include the model management entity 305 of the UE outputting or otherwise providing a request to the prediction entity 310 for the predicted UE-network context/scenario for future N zones (such as predicted coverage zones). The prediction entity 310 may output or otherwise provide the predicted UE-network context/scenario for the future N zones to the model management entity 305. Aspects of prediction model 300 illustrates a non-limiting example of techniques for the prediction entity 310 to identify, determine, or otherwise select the predicted UE-network context/scenario for the future N zones.

For example, this may include a vehicle-UE map and sensor information for the future N zones function. This function may output or otherwise provide information related to the vehicle or UE trip information, traffic information, vehicle IMU information, a gear mode, an IGN status, a no-passenger information, and the like. This information may be provided to a UE-vehicle context prediction function. This function may use this information and output various information to other functions of the prediction entity 310. In some aspects, this information may include outputting information related to the zone identifier(s) for fetching information from the cellular coverage prediction database for the next X meters. This information may be output or otherwise provided to a cellular coverage prediction function of the prediction entity 310.

In some aspects, the UE-vehicle context prediction may output or otherwise provide information related to the possible environment types (such as garage, highway, etc.) tagged with the zone identifier in the next X meters, the environment change instances tagged with the estimated time and zone identifier (such as downtown-to-highway at (T, Zone-ID N)). This information may be output to a combiner function. In some aspects, cellular coverage prediction function may output (such as to the decision function) information related to the predicted signal strength (such as RSRP, RSRQ, SINR), the frequency range type and the inferred network/cell deployment scenario to the combiner function.

The combiner function may output this information to the predicted UE-network scenario for the future N zones function that may use this information to select the model from the plurality of models. For example, this may include square zones (such as 50 meters by 50 meters), such as the predicted coverage zones, for determining the most suitable HL model for CSF time domain prediction and reporting or compression and reporting. The model management entity 305 may query the UE-vehicle context information to determine the most suitable model identifier for ML CSF time-domain prediction for the future N zones. In some aspects, the N zones may be (pre) configurable for the UE. Each predicted coverage zone may correspond to a geographical area (such as 50 m by 50 m area) that the UE is expected to enter within the future defined by the timing parameter.

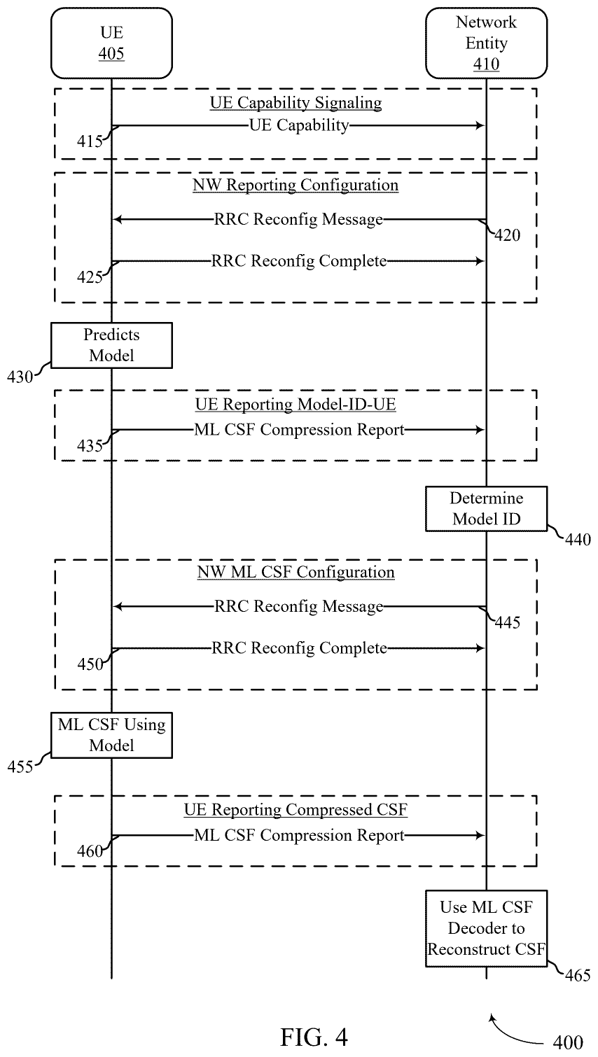

FIG. 4 shows an example of a swim diagram 400 that supports predictive hyper-local model selection for machine learning CSF. Swim diagram 400 may implement aspects of wireless communications system 100 or wireless communications system 200 or aspects of prediction model 300. Aspects of swim diagram 400 may be implemented at or implemented by a UE 405 and a network entity 410, which may be examples of the corresponding devices described herein.

As discussed above, aspects of the techniques described herein also support or otherwise provide for cooperative model selection for ML CSF compression with two-sided models. For example, the UE 405 may receive or otherwise obtain a plurality of models associated with CSF compression and reporting or for CSF time domain prediction and reporting. The plurality of models may include a set of HL model pairs for ML CSF encoder and decoder for different UE and network scenarios that have been trained offline and stored at the UE 405 and the network entity 410, respectively. Each model pail may have its own unique model identifier. That is, the model identifiers and their descriptions and details for ML CSF compression are known by both the UE 405 and the network entity 410.

In some aspects, this may include a cooperative UE-network signaling solution using UE-network signaling frameworks (such as uplink control signaling and UAI signaling) that enable the UE and network to coordinate selecting the most suitable HL model(s) (such as model identifiers) for ML CSF compression while the UE is connected to the cell. Each model identifier may be uniquely represented by the pair of network model identifier and UE model identifier, which are determined by the serving cell and UE, respectively. That is, the model identifier may be based on a function of the network model identifier and the UE model identifier (such as model-ID=f (model-ID-NW, model-ID-UE). The network model identifier or the UE model identifier alone may not provide any information about the model as a value of the network model identifier or UE model identifier can be associated with multiple model identifiers. Moreover, in some aspects the network may not explicitly signal or otherwise signal the network model identifier to the UE.

Instead, the serving cell may determine the network model identifier based on the cell deployment type (such as such as urban micro, urban macro, indoor or outdoor, transmit power level, antenna configuration, or other considerations) and the range of the carrier frequency (such as sub-6 GHZ, low-band, mid-band, high-band, or mmW). The serving cell (such as the network entity 410, in this example) may configure the UE 405 via RRC signaling or DCI signaling to report the UE model identifier periodically or aperiodically using uplink control signaling (such as PUCCH or PUSCH MAC-CE). The UE model identifier selection may be up to implementation of the UE 405. The network entity 410 (such as based on the received information from different UEs, network scheduling or loading, and other information) may select the model identifier and send this information to the UE 405 via RRC signaling or DCI signaling for periodic or semi-persistent and aperiodic MS CSF compression and reporting.

From the perspective of the UE 405, the UE 405 may determine the UE model identifier in a predictive manner based on the predicted cellular coverage information as well as the predicted UE mobility level in a future segment (such as for N future zones) of the UE route (such as future zones) within the predicted UE or vehicle trajectory or path. The cellular coverage information and the UE mobility prediction may be performed according to the techniques described above (such as fur UE-sided HL model selection). As one non-limiting example, the serving cell may select “model-ID-NW=X” based on the cell deployment scenario (such as FDD, SA/NSA, low-band, indoor or outdoor cell deployment) and the UE 405 may choose “model-ID-UE=Y” based on the predicted UE scenario in the next T sections/N zones (such as poor RSRP, poor RSRQ, stationary-vs-parked vehicle, etc.).

In some aspects, the network may not have configured the UE 405 with uplink control resources to report the UE model identifier. In this example, aspects of the techniques described herein provide for the UAI framework to be enhanced to enable the UE 405 to provide the UE model identifier once the UE 405 has predicted a new UE model identifier. This may be applied as the network may not have the most accurate estimation of the UE mobility level and how fast the UE is moving between different environments to configure the optimal UE model identifier reporting periodicity for all UEs.

In some aspects, this may include enhancements to handover (HO) preparation procedure to enable the source-cell to convey the UE model identifier to the target-cell(s) by enhancing the HO request/preparation message. This may help the target-cell(s) during the HO procedure to more quickly prepare the ML CSF scheduling and configuration for the UE after connecting to the cell.

Swim diagram 400 illustrates a high-level summary of the UE-network signaling enhancements to support the proposed ML CSF compression and reporting with two-sided HL models.

This may include a UE capability signaling feature where, at 415, the UE 405 may optionally transmit or otherwise output (and the network entity 410 may receive or otherwise obtain) a UE capability message. The UE capability message may carry or otherwise convey an indication of a support for UE model identifier reporting for CSF compression and reporting. For example, the UE capability message may carry or otherwise convey an indication of a UE-NR-Capability parameter that is set to a value {ML-CSF-Compression=supported, List of Model-ID(s), ML-CSF-Model-ID-UE-Reporting=supported}.

This may include a network reporting configuration where, at 420, the network entity 410 may optionally transmit or otherwise output (and the UE 405 may optionally receive or otherwise obtain) a message identifying a UE model identifier reporting schedule for the UE 405. In this non-limiting example, the message may be carried or otherwise conveyed in a RRC reconfiguration message. In some aspects, the message may be carried or otherwise conveyed in a DCI message. The message may carry or otherwise convey a parameter ML-CSF-Model-ID-UE_reporting-config {Periodic, aperiodic, . . . } parameter. This parameter may identify the reporting schedule for the UE model identifier(s) of the UE 405. At 425, the UE 405 may transmit or otherwise output (and the network entity 410 may receive or otherwise obtain) a confirmation message confirming that the UE 405 has received and successfully decoded the message indicating the UE model identifier reporting schedule. In this non-limiting example, the confirmation message may be carried or otherwise conveyed in a RRC reconfiguration complete message.

At 430, the UE 405 may identify or otherwise determine the predicted model(s) of the UE 405. For example, the UE 405 may obtain a coverage prediction for predicted coverage zone(s) that are associated with respective cellular coverage condition for each predicted coverage zone, as discussed above. The UE 405 may select a model (and the corresponding UE model identifier) based on the coverage prediction.

In some aspects, the message received at 420 may serve as a request for the UE model identifier. That is, the UE 405 may report its selected UE model identifier in according to the reporting schedule such that the message received at 420 serves as a request for a UE model identifier. The request may be provided, in this example, via a RRC reconfiguration message. The UE model identifier may be associated with a model from among a plurality of models associated with CSF compression and reporting. The plurality of models may correspond to respective network deployment scenarios and associated UE scenarios and each have a respective UE model identifier. That is, each model in the plurality of models may have a unique UE model identifier and be associated with a specific UE-network deployment scenario and condition.

Accordingly and during a UE reporting UE model identifier phase, at 435 the UE 405 may transmit or otherwise output (and the network entity 410 may receive or otherwise obtain) an indication of the UE model identifier in accordance with the request. The UE model identifier may be based on or otherwise associated with the coverage prediction for the predicted coverage zone(s) of the UE 405. In this non-limiting example, the indication may be provided in a ML CSF compression report. For example, the ML-CSF compression report may include an indication of a ML-CSF_Model-ID-UE-Report_Container {Model-ID-UE} that conveys the UE model identifier.

At 440, the network entity 410 may use the UE model identifier and a network model identifier to identify, select, or otherwise determine a model identifier to be used for CSF compression and reporting between the UE 405 and the network entity 410. For example, the network entity 410 may determine the model identifier using model-ID=f (model-ID-NW, model-ID-UE) as described above.

During a network ML CSF configuration phase, at 445 the network entity 410 may transmit or otherwise output (and the UE 405 may receive or otherwise obtain) a model identifier. The model identifier may be associated with the UE model identifier and the network model identifier. In some aspects, the model identifier may be provided or otherwise indicated in a RRC reconfiguration message that carries the indication. For example, the RRC reconfiguration message may include or otherwise indicate a ML-CSF_Config {Model-ID} container that conveys the indication.

At 450, the UE 405 may transmit or otherwise output (and the network entity 410 may receive or otherwise obtain) a confirmation message (such as in a RRC reconfiguration complete message) that the UE 405 has successfully received and decoded the indication of the model identifier.

At 455, the UE 405 may perform CSF compression and reporting according to the model identifier. For example, upon receiving the model identifier, the UE 405 may use the corresponding ML-based CSI encoder to compress the eigenvectors of the estimated raw channel matrix for reporting to the network.

During a UE reporting compressed CSF phase, at 460 the UE 405 may transmit or otherwise output (and the network entity 410 may receive or otherwise obtain) a ML CSF compression report. In some aspects, the report may carry or otherwise convey a ML-CSF-Compression-Report-Container={ } that carries the compressed channel information. At 465, the network entity 410 may use the ML CSF decoder to reconstruct the CSF.

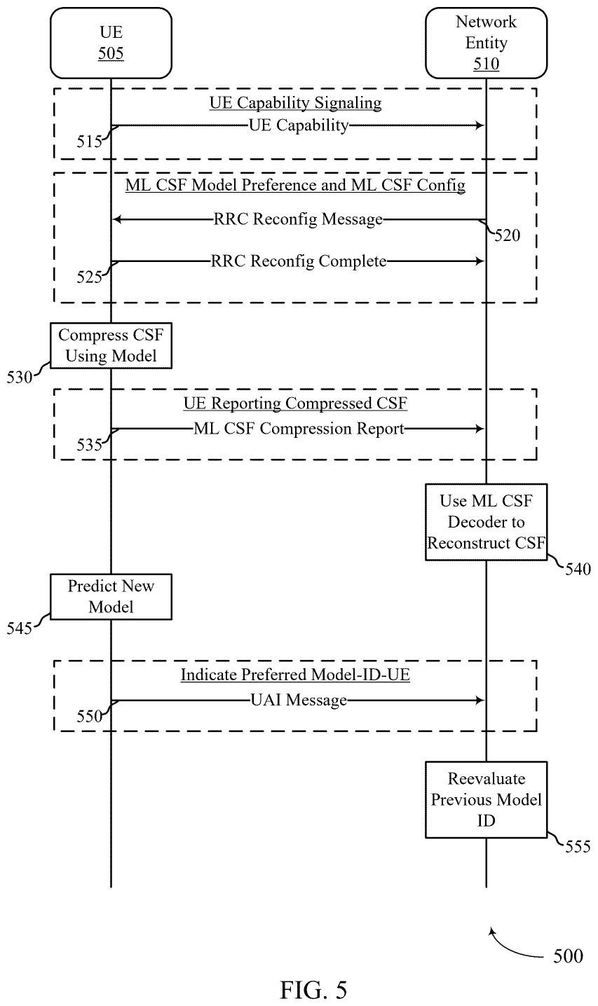

FIG. 5 shows an example of a swim diagram 500 that supports predictive hyper-local model selection for machine learning CSF. Swim diagram 500 may implement aspects of wireless communications system 100 or wireless communications system 200 or aspects of prediction model 300 or aspects of swim diagram 400. Aspects of swim diagram 500 may be implemented at or implemented by a UE 505 and a network entity 510, which may be examples of the corresponding devices described herein.

As discussed above, aspects of the techniques described herein also support or otherwise provide for cooperative model selection for ML CSF compression with two-sided models. For example, the UE 405 may receive or otherwise obtain a plurality of models associated with CSF compression and reporting or for CSF time domain prediction and reporting. The plurality of models may include a set of HL model pairs for ML CSF encoder and decoder for different UE and network scenarios that have been trained offline and stored at the UE 505 and the network entity 510, respectively. Each model pail may have its own unique model identifier. That is, the model identifiers and their descriptions and details for ML CSF compression are known by both the UE 505 and the network entity 510.

In some aspects, this may include a cooperative UE-network signaling solution using UE-network signaling frameworks (such as uplink control signaling and UAI signaling) that enable the UE and network to coordinate selecting the most suitable HL model(s) (such as model identifiers) for ML CSF compression while the UE is connected to the cell. Each model identifier may be uniquely represented by the pair of network model identifier and UE model identifier, which are determined by the serving cell and UE, respectively. That is, the model identifier may be based on a function of the network model identifier and the UE model identifier (such as model-ID=f (model-ID-NW, model-ID-UE). The network model identifier or the UE model identifier alone may not provide any information about the model as a value of the network model identifier or UE model identifier can be associated with multiple model identifiers. Moreover, in some aspects the network may not explicitly signal or otherwise signal the network model identifier to the UE.

Instead, the serving cell may determine the network model identifier based on the cell deployment type (such as such as urban micro, urban macro, indoor or outdoor, transmit power level, antenna configuration, or other considerations) and the range of the carrier frequency (such as sub-6 GHz, low-band, mid-band, high-band, or mmW). The serving cell (such as the network entity 510, in this example) may configure the UE 505 via RRC signaling or DCI signaling to report the UE model identifier periodically or aperiodically using uplink control signaling (such as PUCCH or PUSCH MAC-CE). The UE model identifier selection may be up to implementation of the UE 505. The network entity 510 (such as based on the received information from different UEs, network scheduling or loading, and other information) may select the model identifier and send this information to the UE 505 via RRC signaling or DCI signaling for periodic or semi-persistent and aperiodic MS CSF compression and reporting.

From the perspective of the UE 505, the UE 505 may determine the UE model identifier in a predictive manner based on the predicted cellular coverage information as well as the predicted UE mobility level in a future segment (such as for N future zones) of the UE route (such as future zones) within the predicted UE or vehicle trajectory or path. The cellular coverage information and the UE mobility prediction may be performed according to the techniques described above (such as fur UE-sided HL model selection). As one non-limiting example, the serving cell may select “model-ID-NW=X” based on the cell deployment scenario (such as FDD, SA/NSA, low-band, indoor or outdoor cell deployment) and the UE 505 may choose “model-ID-UE-Y” based on the predicted UE scenario in the next T sections/N zones (such as poor RSRP, poor RSRQ, stationary-vs-parked vehicle, etc.).

In some aspects, the network may not have configured the UE 505 with uplink control resources to report the UE model identifier. In this example, aspects of the techniques described herein provide for the UAI framework to be enhanced to enable the UE 505 to provide the UE model identifier once the UE 505 has predicted a new UE model identifier. This may be applied as the network may not have the most accurate estimation of the UE mobility level and how fast the UE is moving between different environments to configure the optimal UE model identifier reporting periodicity for all UEs.

Swim diagram 500 illustrates a non-limiting example of a high-level summary of the enhanced UE-to-network signaling that builds on the UAI framework for the ML CSF compression with two-sided HL models. In this example, the network may not have configured the UE 505 to report the UE model identifier. Initially, this may include the network configuring the UE 505 with a model identifier based on the network cell deployment type, the frequency range type, and the received UE reference signal measurements without configuring the UE 505 to report the UE model identifier. Once the UE 505 predicts a new UE model identifier, the UE 505 may send the UAI message that includes the updated UE model identifier. If both the UE 505 and the network supports UAI for this purpose, the described techniques may help with control signaling overhead (such as depending on UE scenario and mobility level) as the UE 505 only needs to indicate the (preferred) UE model identifier to the network only upon the prediction changing.

This may include a UE capability signaling phase where, at 515, the UE 505 may optionally transmit or otherwise output (and the network entity 510 may receive or otherwise obtain) a UE capability message. The UE capability message may carry or otherwise convey an indication of a support for UE model identifier reporting for CSF compression and reporting. For example, the UE capability message may carry or otherwise convey an indication of a UE-NR-Capability parameter that is set to a value {ML-CSF-Compression=supported, List of Model-ID(s), ML-CSF-Compression-Model-ID-UE-Reporting=Supported, UAI-ML-CSF-preference-indication=supported, . . . }.

This may include a ML CSF model preference and ML CSF configuration phase where, at 520, the network entity 410 may optionally transmit or otherwise output (and the UE 405 may optionally receive or otherwise obtain) a message identifying ML CSF configuration information for the UE 505. In this non-limiting example, the message may be carried or otherwise conveyed in a RRC reconfiguration message. In some aspects, the message may be carried or otherwise conveyed in a DCI message. The message may carry or otherwise convey a parameter Other-Config {ML-CSF_prefernece_config, . . . }, . . . , ML-CSF_Config (Model-ID) information element. This message may be signaled to the UE 505 to identify the model identifier to be used for ML CSF compression and reporting. At 525, the UE 505 may transmit or otherwise output (and the network entity 510 may receive or otherwise obtain) a confirmation message confirming that the UE 505 has received and successfully decoded the message indicating the model identifier. In this non-limiting example, the confirmation message may be carried or otherwise conveyed in a RRC reconfiguration complete message.

At 530, the UE 505 may identify or otherwise determine the predicted model(s) of the UE 505. For example, the UE 505 may perform CSF compression and reporting according to the model identifier. For example, upon receiving the model identifier, the UE 505 may use the corresponding ML-based CSI encoder to compress the eigenvectors of the estimated raw channel matrix for reporting to the network.

During a UE reporting compressed CSF phase, at 535 the UE 505 may transmit or otherwise output (and the network entity 510 may receive or otherwise obtain) a ML CSF compression report. In some aspects, the report may carry or otherwise convey a ML-CSF-Compression-Report-Container={ } that carries the compressed channel information. At 540, the network entity 510 may use the ML CSF decoder to reconstruct the CSF.

However, at 545 the UE 505 may select or otherwise identify a new model(s) to be used for CSF compression and reporting. For example, the UE 505 may predict the new model(s) based on the CSF time domain prediction and reporting techniques discussed above based on the UE 505 moving along a path or trajectory of new predicted coverage zones (and their respective predicted cellular coverage level). This may result in different models being selected to be used for the future N predicted coverage zones. That is, one the UE 505 predicts a new UE model identifier based on the predicted cellular coverage information, predicted UE environment and the predicted UE mobility level, scenario, the UE 505 may use a UAI message to indicate this information to the network.

According and during an indicating the preferred UE model identifier phase, at 550 the UE 505 may transmit or otherwise output (and the network entity 510 may receive or otherwise obtain) an indication of a UE model identifier. For example, the UE 505 may select a UAI framework for transmitting the UE model identifier. In this aspect, the UAI framework may be selected based on a lack of configured uplink control resources being configured for the UE 505 to use to transmit the UE model identifier. For example, the UAI framework may carry or otherwise convey a ML-CSF_Model-ID-UE-Preference {Model-ID-UE} information element that identifies the UE model identifier.

At 555, the network entity 510 may reevaluate the previous model identifier based on the preferred UE model identifier received from the UE 505. For example, the network entity 510 may reevaluate the previously configured model identifier based on the preferred UE model identifier received from the UE 505 at 550. If needed, the network entity 510 may reconfigure the UE 505 with an updated model identifier for ML CSF encoder operations. That is, the network entity 510 may update the model identifier being used by the UE 505 for CSF compression and reporting based on the updated or preferred UE model identifier sent via UAI signaling.

Accordingly, the techniques describe herein generally provide for UE capability information that is enhanced to enable the UE to advertise its capability regarding ML CSF model-ID-UE reporting during registration (or re-registration) in response to UE capability enquiry message. In some aspects, the RRCreconfig message may be enhanced to enable the network entity 510 to configure the UE 505 with UE control resources for reporting model-ID-UE. In some aspects, the UAI framework may be enhanced to enable the UE 505 to indicate the preferred Model-ID-UE to the network entity 510.

In some aspects, the described UE implementation enhancements for selecting the most suitable HL model for CSF time-domain prediction in vehicular UEs may be based on the predicted cellular coverage information, the predicted UE environment and the predilected UE mobility level (such as for a given UE/vehicle route). The described UE-to-network signaling enhancements and the cooperative mechanism for CSF compression (encoder/decoder) selection are provided. In some aspects, the UAI enhancements and solutions for the UE 505 to indicate and determine the preferred (such as within the proposed cooperative scheme for ML CSF compression encoder/decoder model selection) is provided.

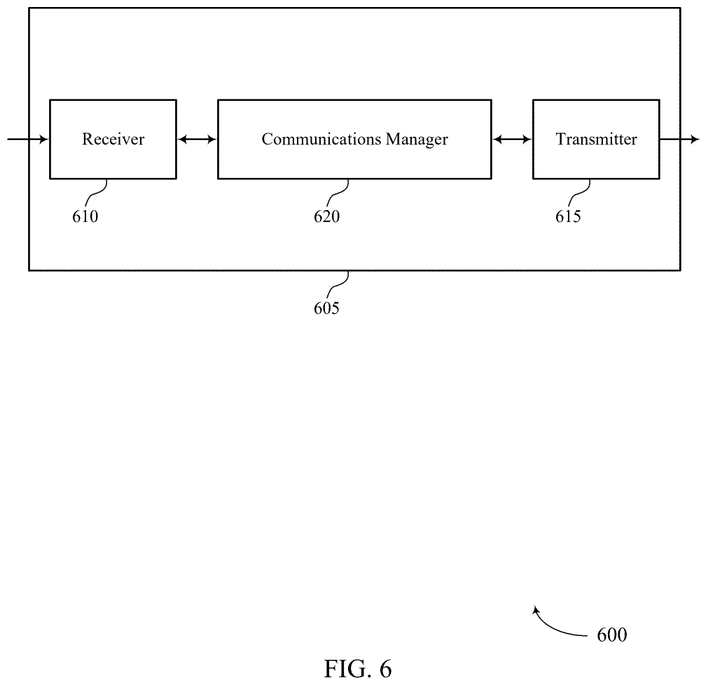

FIG. 6 shows a block diagram 600 of a device 605 that supports predictive hyper-local model selection for machine learning CSF. The device 605 may be an example of aspects of a UE 115 as described herein. The device 605 may include a receiver 610, a transmitter 615, and a communications manager 620. The device 605, or one or more components of the device 605 (such as the receiver 610, the transmitter 615, the communications manager 620), may include at least one processor, which may be coupled with at least one memory, to, individually or collectively, support or enable the described techniques. Each of these components may be in communication with one another (such as via one or more buses).

In some implementations, one or more of the multiple memories may be configured to store processor-executable code that, when executed, may configure one or more of the multiple processors to perform various functions described herein (as part of a processing system). In some other implementations, the processing system may be pre-configured to perform various functions described herein.

The receiver 610 may provide a means for receiving information such as packets, user data, control information, or any combination thereof associated with various information channels (such as control channels, data channels, information channels related to predictive hyper-local model selection for machine learning CSF). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (such as control channels, data channels, information channels related to predictive hyper-local model selection for machine learning CSF). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of predictive hyper-local model selection for machine learning CSF as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (such as in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (such as by one or more processors, individually or collectively, executing instructions stored in the at least one memory).

Additionally, or alternatively, the communications manager 620, the receiver 610, the transmitter 615, or various combinations or components thereof may be implemented in code (such as communications management software or firmware) executed by at least one processor (such as referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (such as configured as or otherwise supporting, individually or collectively, a means for performing the functions described in the present disclosure).

In some examples, the communications manager 620 may be configured to perform various operations (such as receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for obtaining a set of multiple models associated with CSF time domain prediction and reporting or CSF compression and reporting, the set of multiple models corresponding to respective network deployment scenarios and associated UE scenarios. The communications manager 620 is capable of, configured to, or operable to support a means for obtaining a coverage prediction for one or more predicted coverage zones of the UE, the coverage prediction associated with a respective cellular coverage condition for each predicted coverage zone. The communications manager 620 is capable of, configured to, or operable to support a means for selecting a model from the set of multiple models in accordance with the coverage prediction. The communications manager 620 is capable of, configured to, or operable to support a means for performing CSF time domain prediction and reporting or CSF compression and reporting according to the model.

Additionally, or alternatively, the communications manager 620 may support wireless communications in accordance with examples as disclosed herein. For example, the communications manager 620 is capable of, configured to, or operable to support a means for receiving a request for a UE model identifier from a network entity, the UE model identifier associated with a model from among a set of multiple models associated with CSF compression and reporting, the set of multiple models corresponding to respective network deployment scenarios and associated UE scenarios and having respective UE model identifiers. The communications manager 620 is capable of, configured to, or operable to support a means for transmitting the UE model identifier in accordance with the request, the UE model identifier associated with a coverage prediction for one or more predicted coverage zones of the UE. The communications manager 620 is capable of, configured to, or operable to support a means for receiving a model identifier from the network entity, the model identifier associated with the UE model identifier and a network model identifier. The communications manager 620 is capable of, configured to, or operable to support a means for performing CSF compression and reporting according to the model identifier.

By including or configuring the communications manager 620 in accordance with examples as described herein, the device 605 (such as at least one processor controlling or otherwise coupled with the receiver 610, the transmitter 615, the communications manager 620, or a combination thereof) may support techniques for enhancements for selecting the most suitable HL model for CSF time-domain prediction in vehicular UEs based on the predicted cell coverage information, predicted UE environment and predilected UE mobility level (such as for a given UE/vehicle route). Improved UE-network signaling enhancements and a cooperative mechanism for CSF compression (encoder/decoder) selection are also described. This may include UAI enhancements and solutions for a UE to indicate and determine the preferred (such as within the proposed cooperative scheme for ML CSF compression encoder/decoder model selection) model.

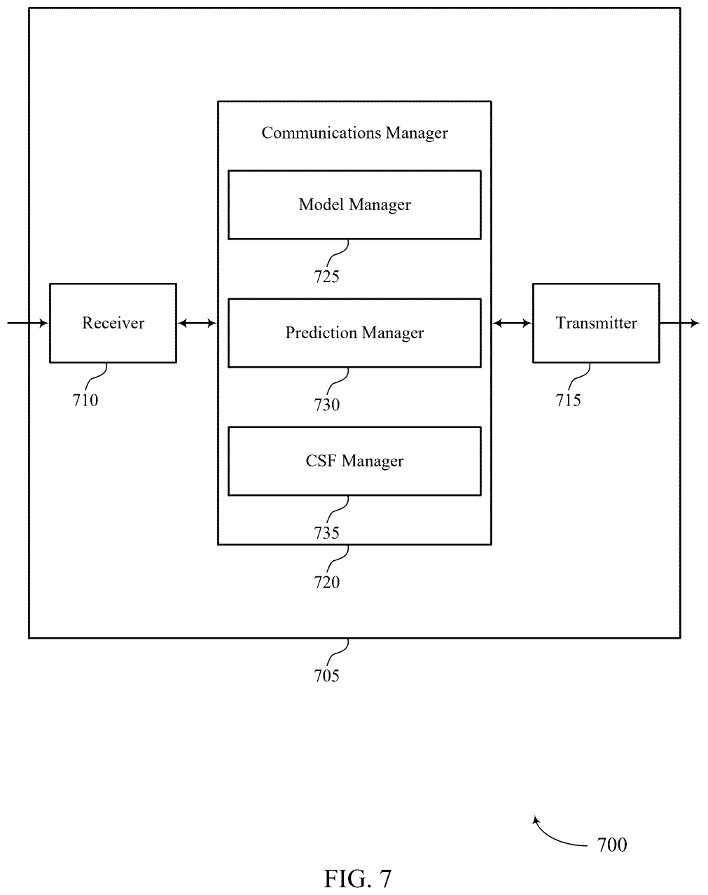

FIG. 7 shows a block diagram 700 of a device 705 that supports predictive hyper-local model selection for machine learning CSF. The device 705 may be an example of aspects of a device 605 or a UE 115 as described herein. The device 705 may include a receiver 710, a transmitter 715, and a communications manager 720. The device 705, or one of more components of the device 705 (such as the receiver 710, the transmitter 715, the communications manager 720), may include at least one processor, which may be coupled with at least one memory, to support the described techniques. Each of these components may be in communication with one another (such as via one or more buses).

The receiver 710 may provide a means for receiving information such as packets, user data, control information, or any combination thereof associated with various information channels (such as control channels, data channels, information channels related to predictive hyper-local model selection for machine learning CSF). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (such as control channels, data channels, information channels related to predictive hyper-local model selection for machine learning CSF). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of predictive hyper-local model selection for machine learning CSF as described herein. For example, the communications manager 720 may include a model manager 725, a prediction manager 730, an CSF manager 735, or any combination thereof. The communications manager 720 may be an example of aspects of a communications manager 620 as described herein. In some examples, the communications manager 720, or various components thereof, may be configured to perform various operations (such as receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The model manager 725 is capable of, configured to, or operable to support a means for obtaining a set of multiple models associated with CSF time domain prediction and reporting or CSF compression and reporting, the set of multiple models corresponding to respective network deployment scenarios and associated UE scenarios. The prediction manager 730 is capable of, configured to, or operable to support a means for obtaining a coverage prediction for one or more predicted coverage zones of the UE, the coverage prediction associated with a respective cellular coverage condition for each predicted coverage zone. The model manager 725 is capable of, configured to, or operable to support a means for selecting a model from the set of multiple models in accordance with the coverage prediction. The CSF manager 735 is capable of, configured to, or operable to support a means for performing CSF time domain prediction and reporting or CSF compression and reporting according to the model.

Additionally, or alternatively, the communications manager 720 may support wireless communications in accordance with examples as disclosed herein. The model manager 725 is capable of, configured to, or operable to support a means for receiving a request for a UE model identifier from a network entity, the UE model identifier associated with a model from among a set of multiple models associated with CSF compression and reporting, the set of multiple models corresponding to respective network deployment scenarios and associated UE scenarios and having respective UE model identifiers. The model manager 725 is capable of, configured to, or operable to support a means for transmitting the UE model identifier in accordance with the request, the UE model identifier associated with a coverage prediction for one or more predicted coverage zones of the UE. The model manager 725 is capable of, configured to, or operable to support a means for receiving a model identifier from the network entity, the model identifier associated with the UE model identifier and a network model identifier. The CSF manager 735 is capable of, configured to, or operable to support a means for performing CSF compression and reporting according to the model identifier.

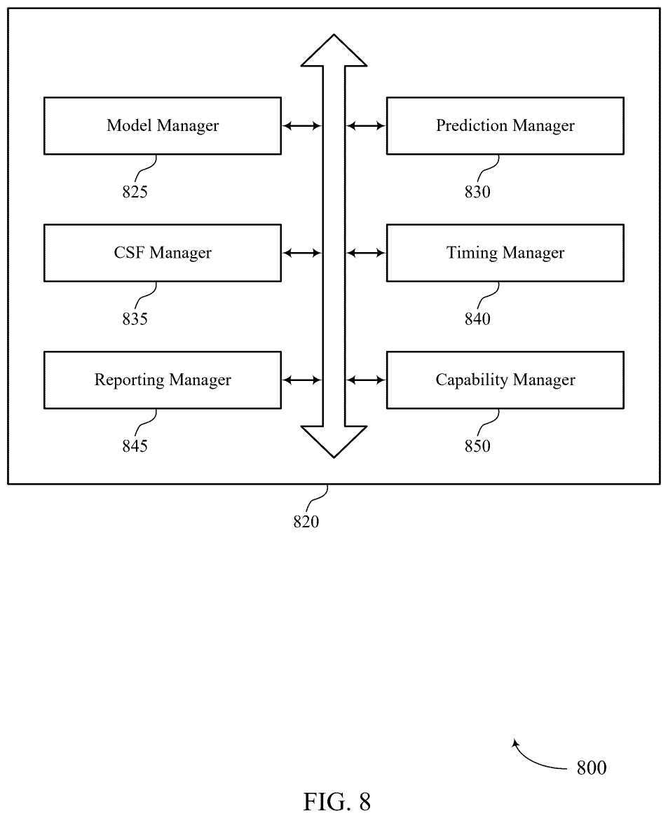

FIG. 8 shows a block diagram 800 of a communications manager 820 that supports predictive hyper-local model selection for machine learning CSF. The communications manager 820 may be an example of aspects of a communications manager 620, a communications manager 720, or both, as described herein. The communications manager 820, or various components thereof, may be an example of means for performing various aspects of predictive hyper-local model selection for machine learning CSF as described herein. For example, the communications manager 820 may include a model manager 825, a prediction manager 830, an CSF manager 835, a timing manager 840, a reporting manager 845, a capability manager 850, or any combination thereof. Each of these components, or components or subcomponents thereof (such as one or more processors, one or more memories), may communicate, directly or indirectly, with one another (such as via one or more buses).

The communications manager 820 may support wireless communications in accordance with examples as disclosed herein. The model manager 825 is capable of, configured to, or operable to support a means for obtaining a set of multiple models associated with CSF time domain prediction and reporting or CSF compression and reporting, the set of multiple models corresponding to respective network deployment scenarios and associated UE scenarios. The prediction manager 830 is capable of, configured to, or operable to support a means for obtaining a coverage prediction for one or more predicted coverage zones of the UE, the coverage prediction associated with a respective cellular coverage condition for each predicted coverage zone. In some examples, the model manager 825 is capable of, configured to, or operable to support a means for selecting a model from the set of multiple models in accordance with the coverage prediction. The CSF manager 835 is capable of, configured to, or operable to support a means for performing CSF time domain prediction and reporting or CSF compression and reporting according to the model.

In some examples, the respective network deployment scenarios and associated UE scenarios correspond to one or more of an RSRP, an RSRQ, an FDD configuration, an SA configuration, a frequency band, a mobility level, an outdoor state, an indoor state, an antenna port configuration, or any combination thereof.

In some examples, the timing manager 840 is capable of, configured to, or operable to support a means for obtaining an indication of a timing parameter associated with the one or more predicted coverage zones, the selecting of the model being in accordance with the timing parameter. In some examples, the respective cellular coverage condition for a predicted coverage zone includes one or more of a predicted cellular coverage level, a predicted environment type, a predicted UE mobility level, a predicted RSRP, a predicted signal quality, a predicted frequency band, or a predicted network deployment scenario.

In some examples, the respective cellular coverage condition for a predicted coverage zone is determined in accordance with one or more of a reference signal measurement, an RRC configuration, uplink or downlink grant information, historical information, or any combination thereof. In some examples, the respective cellular coverage condition for a predicted coverage zone is determined in accordance with UE information associated with the UE or one or more other UEs.

Additionally, or alternatively, the communications manager 820 may support wireless communications in accordance with examples as disclosed herein. In some examples, the model manager 825 is capable of, configured to, or operable to support a means for receiving a request for a UE model identifier from a network entity, the UE model identifier associated with a model from among a set of multiple models associated with CSF compression and reporting, the set of multiple models corresponding to respective network deployment scenarios and associated UE scenarios and having respective UE model identifiers. In some examples, the model manager 825 is capable of, configured to, or operable to support a means for transmitting the UE model identifier in accordance with the request, the UE model identifier associated with a coverage prediction for one or more predicted coverage zones of the UE. In some examples, the model manager 825 is capable of, configured to, or operable to support a means for receiving a model identifier from the network entity, the model identifier associated with the UE model identifier and a network model identifier. In some examples, the CSF manager 835 is capable of, configured to, or operable to support a means for performing CSF compression and reporting according to the model identifier.

In some examples, the model manager 825 is capable of, configured to, or operable to support a means for obtaining the set of multiple models associated with CSF compression and reporting. In some examples, the prediction manager 830 is capable of, configured to, or operable to support a means for obtaining the coverage prediction for the one or more predicted coverage zones of the UE, the coverage prediction associated with a respective cellular coverage condition for each predicted coverage zone. In some examples, the model manager 825 is capable of, configured to, or operable to support a means for selecting the UE model identifier in accordance with the coverage prediction.

In some examples, the reporting manager 845 is capable of, configured to, or operable to support a means for receiving a message identifying a UE model identifier reporting schedule for the UE, the request for the UE model identifier being in accordance with the message. In some examples, the message includes at least one of an RRC message or a DCI message. In some examples, the respective network deployment scenarios and associated UE scenarios correspond to one or more of an RSRP, an RSRQ, an FDD configuration, an SA configuration, a frequency band, a mobility level, an outdoor state, an indoor state, an antenna port configuration, or any combination thereof.

In some examples, the coverage prediction is associated with a respective cellular coverage condition for a predicted coverage zone that includes one or more of a predicted cellular coverage level, a predicted environment type, a predicted UE mobility level, a predicted RSRP, a predicted signal quality, a predicted frequency band, or a predicted network deployment scenario. In some examples, the coverage prediction is associated with a respective cellular coverage condition for each predicted coverage zone that is determined in accordance with one or more of a reference signal measurement, an RRC configuration, uplink or downlink grant information, historical information, or any combination thereof.

In some examples, the reporting manager 845 is capable of, configured to, or operable to support a means for selecting a UAI framework for transmitting the UE model identifier, the transmitting of the UE model identifier being in accordance with the selected UAI framework. In some examples, the UAI framework is selected in response to a lack of configured uplink control resources for transmitting the UE model identifier.

In some examples, the capability manager 850 is capable of, configured to, or operable to support a means for transmitting a UE capability message indicating support for UE model identifier reporting for CSF compression and reporting, the receiving of the request for the UE model identifier being in accordance with the UE capability message. In some examples, the capability manager 850 is capable of, configured to, or operable to support a means for receiving a configuration for uplink control resources, the transmitting of the UE model identifier being via the uplink control resources.

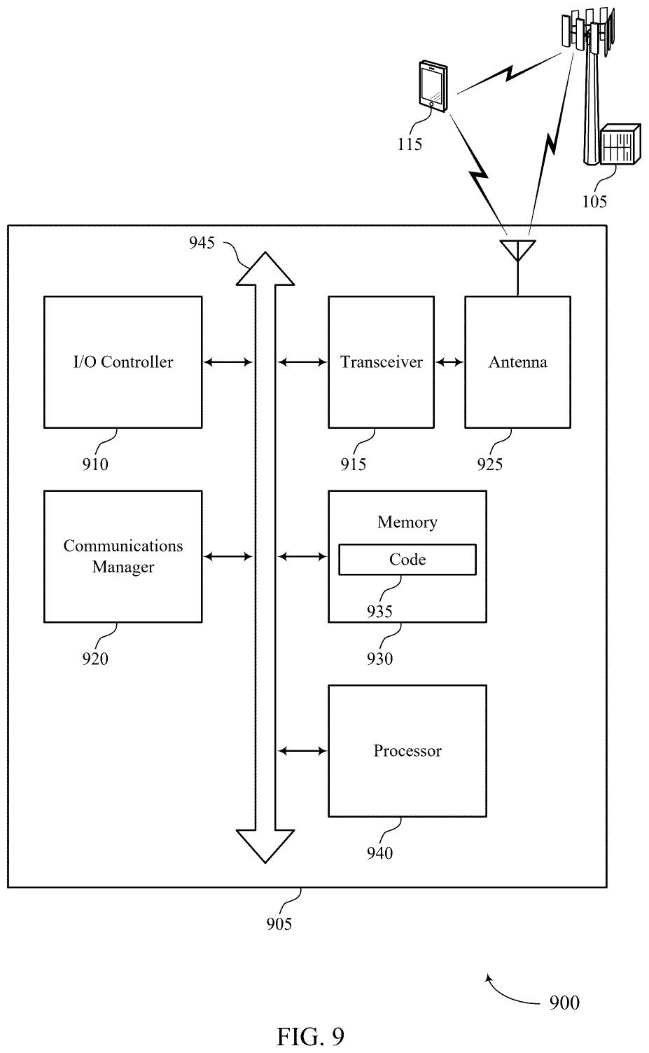

FIG. 9 shows a diagram of a system 900 including a device 905 that supports predictive hyper-local model selection for machine learning CSF. The device 905 may be an example of or include components of a device 605, a device 705, or a UE 115 as described herein. The device 905 may communicate (such as wirelessly) with one or more other devices (such as network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (such as operatively, communicatively, functionally, electronically, electrically) via one or more buses (such as a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (such as when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (such as one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (such as the at least one memory 930) to cause the device 905 to perform various functions (such as functions or tasks supporting predictive hyper-local model selection for machine learning CSF). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (such as processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for obtaining a set of multiple models associated with CSF, the set of multiple models corresponding to respective network deployment scenarios and associated UE scenarios. The communications manager 920 is capable of, configured to, or operable to support a means for obtaining a coverage prediction for one or more predicted coverage zones of the UE, the coverage prediction associated with a respective cellular coverage condition for each predicted coverage zone. The communications manager 920 is capable of, configured to, or operable to support a means for selecting a model from the set of multiple models in accordance with the coverage prediction. The communications manager 920 is capable of, configured to, or operable to support a means for performing CSF time domain prediction and reporting or CSF compression and reporting according to the model.

Additionally, or alternatively, the communications manager 920 may support wireless communications in accordance with examples as disclosed herein. For example, the communications manager 920 is capable of, configured to, or operable to support a means for receiving a request for a UE model identifier from a network entity, the UE model identifier associated with a model from among a set of multiple models associated with CSF compression and reporting, the set of multiple models corresponding to respective network deployment scenarios and associated UE scenarios and having respective UE model identifiers. The communications manager 920 is capable of, configured to, or operable to support a means for transmitting the UE model identifier in accordance with the request, the UE model identifier associated with a coverage prediction for one or more predicted coverage zones of the UE. The communications manager 920 is capable of, configured to, or operable to support a means for receiving a model identifier from the network entity, the model identifier associated with the UE model identifier and a network model identifier. The communications manager 920 is capable of, configured to, or operable to support a means for performing CSF compression and reporting according to the model identifier.

By including or configuring the communications manager 920 in accordance with examples as described herein, the device 905 may support techniques for enhancements for selecting the most suitable HL model for CSF time-domain prediction in vehicular UEs based on the predicted cell coverage information, predicted UE environment and predilected UE mobility level (such as for a given UE/vehicle route). Improved UE-network signaling enhancements and a cooperative mechanism for CSF compression (encoder/decoder) selection are also described. This may include UAI enhancements and solutions for a UE to indicate and determine the preferred (such as within the proposed cooperative scheme for ML CSF compression encoder/decoder model selection) model.

In some examples, the communications manager 920 may be configured to perform various operations (such as receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of predictive hyper-local model selection for machine learning CSF as described herein, or the at least one processor 940 and the at least one memory 930 may be otherwise configured to, individually or collectively, perform or support such operations.

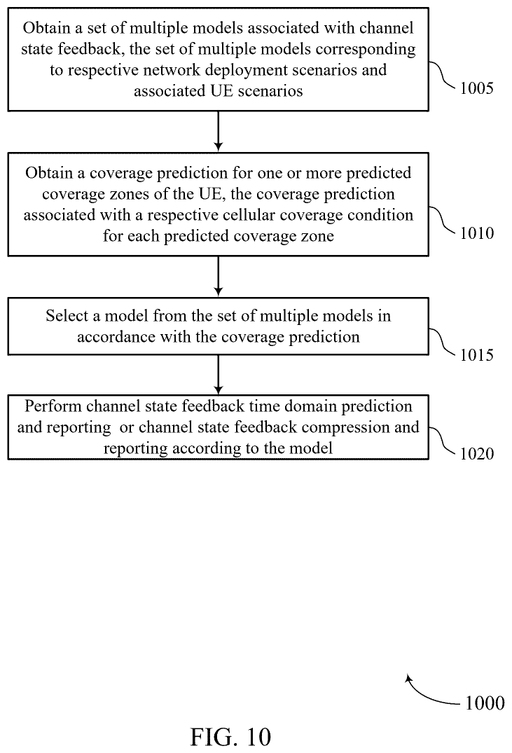

FIG. 10 shows a flowchart illustrating a method 1000 that supports predictive hyper-local model selection for machine learning CSF. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include obtaining a set of multiple models associated with CSF, the set of multiple models corresponding to respective network deployment scenarios and associated UE scenarios. The operations of 1005 may be performed in accordance with examples as disclosed herein. In some examples, aspects of the operations of 1005 may be performed by a model manager 825 as described with reference to FIG. 8.

At 1010, the method may include obtaining a coverage prediction for one or more predicted coverage zones of the UE, the coverage prediction associated with a respective cellular coverage condition for each predicted coverage zone. The operations of 1010 may be performed in accordance with examples as disclosed herein. In some examples, aspects of the operations of 1010 may be performed by a prediction manager 830 as described with reference to FIG. 8.

At 1015, the method may include selecting a model from the set of multiple models in accordance with the coverage prediction. The operations of 1015 may be performed in accordance with examples as disclosed herein. In some examples, aspects of the operations of 1015 may be performed by a model manager 825 as described with reference to FIG. 8.

At 1020, the method may include performing CSF time domain prediction and reporting or CSF compression and reporting according to the model. The operations of 1020 may be performed in accordance with examples as disclosed herein. In some examples, aspects of the operations of 1020 may be performed by an CSF manager 835 as described with reference to FIG. 8.

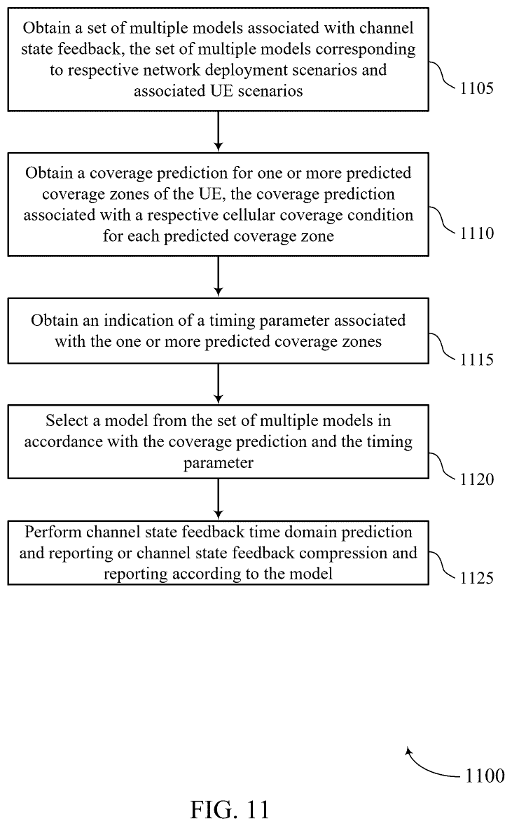

FIG. 11 shows a flowchart illustrating a method 1100 that supports predictive hyper-local model selection for machine learning CSF. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include obtaining a set of multiple models associated with CSF, the set of multiple models corresponding to respective network deployment scenarios and associated UE scenarios. The operations of 1105 may be performed in accordance with examples as disclosed herein. In some examples, aspects of the operations of 1105 may be performed by a model manager 825 as described with reference to FIG. 8.

At 1110, the method may include obtaining a coverage prediction for one or more predicted coverage zones of the UE, the coverage prediction associated with a respective cellular coverage condition for each predicted coverage zone. The operations of 1110 may be performed in accordance with examples as disclosed herein. In some examples, aspects of the operations of 1110 may be performed by a prediction manager 830 as described with reference to FIG. 8.

At 1115, the method may include obtaining an indication of a timing parameter associated with the one or more predicted coverage zones. The operations of 1115 may be performed in accordance with examples as disclosed herein. In some examples, aspects of the operations of 1115 may be performed by a timing manager 840 as described with reference to FIG. 8.

At 1120, the method may include selecting a model from the set of multiple models in accordance with the coverage prediction and the timing parameter. The operations of 1120 may be performed in accordance with examples as disclosed herein. In some examples, aspects of the operations of 1120 may be performed by a model manager 825 as described with reference to FIG. 8.

At 1125, the method may include performing CSF time domain prediction and reporting or CSF compression and reporting according to the model. The operations of 1125 may be performed in accordance with examples as disclosed herein. In some examples, aspects of the operations of 1125 may be performed by an CSF manager 835 as described with reference to FIG. 8.

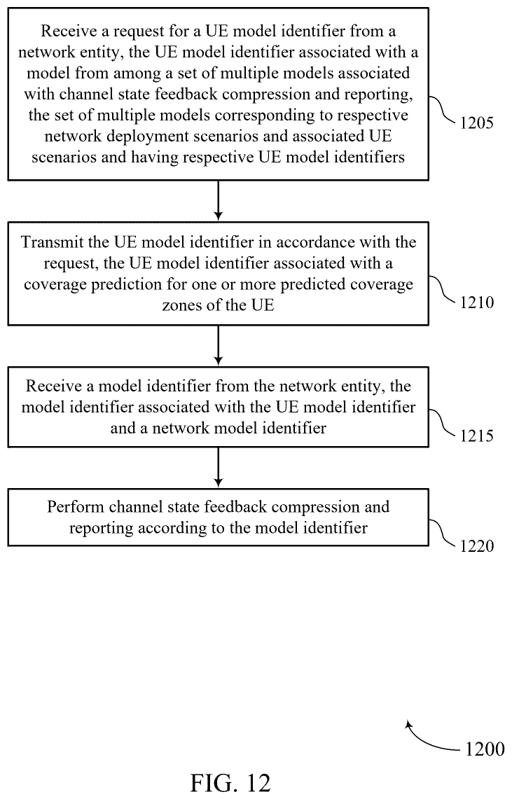

FIG. 12 shows a flowchart illustrating a method 1200 that supports predictive hyper-local model selection for machine learning CSF. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include receiving a request for a UE model identifier from a network entity, the UE model identifier associated with a model from among a set of multiple models associated with CSF compression and reporting, the set of multiple models corresponding to respective network deployment scenarios and associated UE scenarios and having respective UE model identifiers. The operations of 1205 may be performed in accordance with examples as disclosed herein. In some examples, aspects of the operations of 1205 may be performed by a model manager 825 as described with reference to FIG. 8.

At 1210, the method may include transmitting the UE model identifier in accordance with the request, the UE model identifier associated with a coverage prediction for one or more predicted coverage zones of the UE. The operations of 1210 may be performed in accordance with examples as disclosed herein. In some examples, aspects of the operations of 1210 may be performed by a model manager 825 as described with reference to FIG. 8.

At 1215, the method may include receiving a model identifier from the network entity, the model identifier associated with the UE model identifier and a network model identifier. The operations of 1215 may be performed in accordance with examples as disclosed herein. In some examples, aspects of the operations of 1215 may be performed by a model manager 825 as described with reference to FIG. 8.

At 1220, the method may include performing CSF compression and reporting according to the model identifier. The operations of 1220 may be performed in accordance with examples as disclosed herein. In some examples, aspects of the operations of 1220 may be performed by an CSF manager 835 as described with reference to FIG. 8.

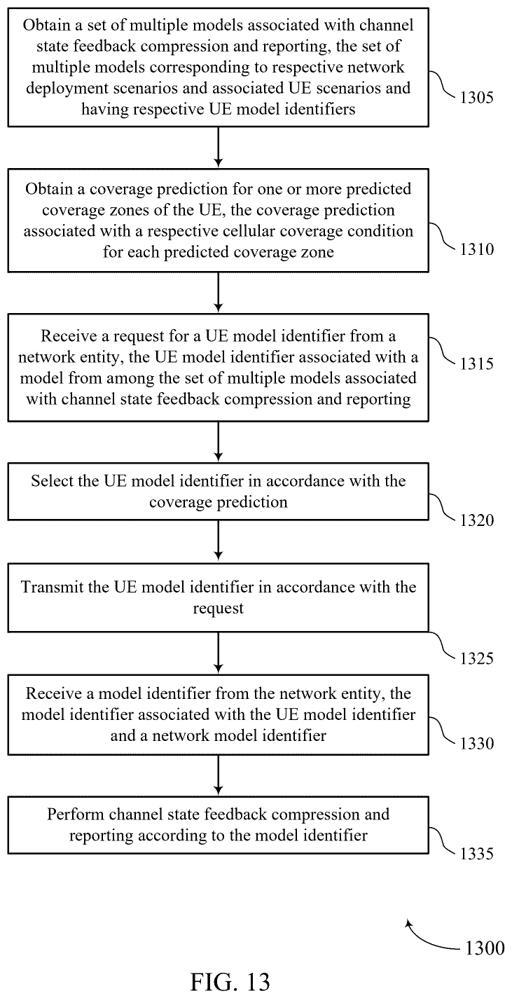

FIG. 13 shows a flowchart illustrating a method 1300 that supports predictive hyper-local model selection for machine learning CSF. The operations of the method 1300 may be implemented by a UE or its components as described herein. For example, the operations of the method 1300 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1305, the method may include obtaining a set of multiple models associated with CSF compression and reporting, the set of multiple models corresponding to respective network deployment scenarios and associated UE scenarios and having respective UE model identifiers. The operations of 1305 may be performed in accordance with examples as disclosed herein. In some examples, aspects of the operations of 1305 may be performed by a model manager 825 as described with reference to FIG. 8.

At 1310, the method may include obtaining a coverage prediction for one or more predicted coverage zones of the UE, the coverage prediction associated with a respective cellular coverage condition for each predicted coverage zone. The operations of 1310 may be performed in accordance with examples as disclosed herein. In some examples, aspects of the operations of 1310 may be performed by a prediction manager 830 as described with reference to FIG. 8.

At 1315, the method may include receiving a request for a UE model identifier from a network entity, the UE model identifier associated with a model from among the set of multiple models associated with CSF compression and reporting. The operations of 1315 may be performed in accordance with examples as disclosed herein. In some examples, aspects of the operations of 1315 may be performed by a model manager 825 as described with reference to FIG. 8.

At 1320, the method may include selecting the UE model identifier in accordance with the coverage prediction. The operations of 1320 may be performed in accordance with examples as disclosed herein. In some examples, aspects of the operations of 1320 may be performed by a model manager 825 as described with reference to FIG. 8.

At 1325, the method may include transmitting the UE model identifier in accordance with the request. The operations of 1325 may be performed in accordance with examples as disclosed herein. In some examples, aspects of the operations of 1325 may be performed by a model manager 825 as described with reference to FIG. 8.

At 1330, the method may include receiving a model identifier from the network entity, the model identifier associated with the UE model identifier and a network model identifier. The operations of 1330 may be performed in accordance with examples as disclosed herein. In some examples, aspects of the operations of 1330 may be performed by a model manager 825 as described with reference to FIG. 8.

At 1335, the method may include performing CSF compression and reporting according to the model identifier. The operations of 1335 may be performed in accordance with examples as disclosed herein. In some examples, aspects of the operations of 1335 may be performed by an CSF manager 835 as described with reference to FIG. 8.

The following provides an overview of aspects of the present disclosure:

Aspect 1: A method for wireless communications at a UE, comprising: obtaining a plurality of models associated with CSF time domain prediction and reporting or compression and reporting, the plurality of models corresponding to respective network deployment scenarios and associated UE scenarios; obtaining a coverage prediction for one or more predicted coverage zones of the UE, the coverage prediction associated with a respective cellular coverage condition for each predicted coverage zone; selecting a model from the plurality of models in accordance with the coverage prediction; and performing CSF time domain prediction and reporting or compression and reporting according to the model.

Aspect 2: The method of aspect 1, wherein the respective network deployment scenarios and associated UE scenarios correspond to one or more of a RSRP level, a RSRQ, an FDD configuration, a SA configuration, a frequency band, a mobility level, an outdoor state, an indoor state, an antenna port configuration, or any combination thereof.

Aspect 3: The method of any of aspects 1 through 2, further comprising: obtaining an indication of a timing parameter associated with the one or more predicted coverage zones, the selecting of the model being in accordance with the timing parameter.

Aspect 4: The method of any of aspects 1 through 3, wherein the respective cellular coverage condition for a predicted coverage zone comprises one or more of a predicted cellular coverage level, a predicted environment type, a predicted UE mobility level, a PRSRP, a predicted signal quality, a predicted frequency band, or a predicted network deployment scenario.

Aspect 5: The method of any of aspects 1 through 4, wherein the respective cellular coverage condition for a predicted coverage zone is determined in accordance with one or more of a reference signal measurement, an RRC configuration, uplink or downlink grant information, historical information, or any combination thereof.

Aspect 6: The method of any of aspects 1 through 5, wherein the respective cellular coverage condition for a predicted coverage zone is determined in accordance with UE information associated with the UE or one or more other UEs.

Aspect 7: A method for wireless communications at a UE, comprising: receiving a request for a UE model identifier from a network entity, the UE model identifier associated with a model from among a plurality of models associated with CSF compression and reporting, the plurality of models corresponding to respective network deployment scenarios and associated UE scenarios and having respective UE model identifiers; transmitting the UE model identifier in accordance with the request, the UE model identifier associated with a coverage prediction for one or more predicted coverage zones of the UE; receiving a model identifier from the network entity, the model identifier associated with the UE model identifier and a network model identifier; and performing CSF compression and reporting according to the model identifier.

Aspect 8: The method of aspect 7, further comprising: obtaining the plurality of models associated with CSF compression and reporting; obtaining the coverage prediction for the one or more predicted coverage zones of the UE, the coverage prediction associated with a respective cellular coverage condition for each predicted coverage zone; and selecting the UE model identifier in accordance with the coverage prediction.

Aspect 9: The method of any of aspects 7 through 8, further comprising: receiving a message identifying a UE model identifier reporting schedule for the UE, the request for the UE model identifier being in accordance with the message.

Aspect 10: The method of aspect 9, wherein the message comprises at least one of an RRC message or a DCI message.

Aspect 11: The method of any of aspects 7 through 10, wherein the respective network deployment scenarios and associated UE scenarios correspond to one or more of a RSRP level, a RSRQ, an FDD configuration, a SA configuration, a frequency band, a mobility level, an outdoor state, an indoor state, an antenna port configuration, or any combination thereof.

Aspect 12: The method of any of aspects 7 through 11, wherein the coverage prediction is associated with a respective cellular coverage condition for a predicted coverage zone that comprises one or more of a predicted cellular coverage level, a predicted environment type, a predicted UE mobility level, a PRSRP, a predicted signal quality, a predicted frequency band, or a predicted network deployment scenario.

Aspect 13: The method of any of aspects 7 through 12, wherein the coverage prediction is associated with a respective cellular coverage condition for each predicted coverage zone that is determined in accordance with one or more of a reference signal measurement, an RRC configuration, uplink or downlink grant information, historical information, or any combination thereof.

Aspect 14: The method of any of aspects 7 through 13, further comprising: selecting a UAI framework for transmitting the UE model identifier, the transmitting of the UE model identifier being in accordance with the selected UAI framework.

Aspect 15: The method of aspect 14, wherein the UAI framework is selected in response to a lack of configured uplink control resources for transmitting the UE model identifier.

Aspect 16: The method of any of aspects 7 through 15, further comprising: transmitting a UE capability message indicating support for UE model identifier reporting for CSF compression and reporting, the receiving of the request for the UE model identifier being in accordance with the UE capability message.

Aspect 17: The method of any of aspects 7 through 16, further comprising: receiving a configuration for uplink control resources, the transmitting of the UE model identifier being via the uplink control resources.

Aspect 18: An apparatus for wireless communications at a UE, comprising a processing system that includes one or more processors and one or more memories coupled with the one or more processors, the processing system configured to cause the apparatus to perform a method of any of aspects 1 through 6.

Aspect 19: A UE for wireless communications, comprising at least one means for performing a method of any of aspects 1 through 6.

Aspect 20: A non-transitory computer-readable medium storing code for wireless communications, the code comprising instructions executable by one or more processors to perform a method of any of aspects 1 through 6.

Aspect 21: An apparatus for wireless communications at a UE, comprising a processing system that includes one or more processors and one or more memories coupled with the one or more processors, the processing system configured to cause the apparatus to perform a method of any of aspects 7 through 17.

Aspect 22: A UE for wireless communications, comprising at least one means for performing a method of any of aspects 7 through 17.

Aspect 23: A non-transitory computer-readable medium storing code for wireless communications, the code comprising instructions executable by one or more processors to perform a method of any of aspects 7 through 17.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (such as a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (such as a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrases “based at least in part on,” “associated with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

As used herein, the term “determine” or “determining” encompasses a wide variety of actions and, therefore, “determining” can include calculating, computing, processing, deriving, investigating, looking up (such as via looking up in a table, a database, or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processing system that includes one or more processors and one or more memories coupled with the one or more processors, the processing system configured to cause the apparatus to:
receive a request for a UE model identifier from a network entity, the UE model identifier associated with a model from among a plurality of models associated with channel state feedback compression and reporting, the plurality of models corresponding to respective network deployment scenarios and associated UE scenarios and having respective UE model identifiers;
transmit the UE model identifier in accordance with the request, the UE model identifier associated with a coverage prediction for one or more predicted coverage zones of the UE;
receive a model identifier from the network entity, the model identifier associated with the UE model identifier and a network model identifier; and
perform channel state feedback compression and reporting according to the model identifier.

2. The apparatus of claim 1, wherein the processing system is further configured to cause the apparatus to:
obtain the plurality of models associated with channel state feedback compression and reporting;
obtain the coverage prediction for the one or more predicted coverage zones of the UE, the coverage prediction associated with a respective cellular coverage condition for each predicted coverage zone; and
select the UE model identifier in accordance with the coverage prediction.

3. The apparatus of claim 1, wherein the processing system is further configured to cause the apparatus to:
receive a message identifying a UE model identifier reporting schedule for the UE, the request for the UE model identifier being in accordance with the message.

4. The apparatus of claim 3, wherein the message comprises at least one of a radio resource control (RRC) message or a downlink control information (DCI) message.

5. The apparatus of claim 1, wherein the respective network deployment scenarios and associated UE scenarios correspond to one or more of a reference signal received power (RSRP), a reference signal received quality (RSRQ), a frequency division duplexing (FDD) configuration, a stand-alone (SA) configuration, a frequency band, a mobility level, an outdoor state, an indoor state, an antenna port configuration, or any combination thereof.

6. The apparatus of claim 1, wherein the coverage prediction is associated with a respective cellular coverage condition for a predicted coverage zone that comprises one or more of a predicted cellular coverage level, a predicted environment type, a predicted UE mobility level, a predicted reference signal received power (RSRP), a predicted signal quality, a predicted frequency band, or a predicted network deployment scenario.

7. The apparatus of claim 1, wherein the coverage prediction is associated with a respective cellular coverage condition for each predicted coverage zone that is determined in accordance with one or more of a reference signal measurement, a radio resource control (RRC) configuration, uplink or downlink grant information, historical information, or any combination thereof.

8. The apparatus of claim 1, wherein the processing system is further configured to cause the apparatus to:
select a UE assistance information (UAI) framework for transmitting the UE model identifier, the transmission of the UE model identifier being in accordance with the selected UAI framework.

9. The apparatus of claim 8, wherein the processing system is configured to cause the apparatus to select the UAI framework in response to a lack of configured uplink control resources for transmitting the UE model identifier.

10. The apparatus of claim 1, wherein the processing system is further configured to cause the apparatus to:
transmit a UE capability message indicating support for UE model identifier reporting for channel state feedback compression and reporting, the reception of the request for the UE model identifier being in accordance with the UE capability message.

11. The apparatus of claim 1, wherein the processing system is further configured to cause the apparatus to:
receive a configuration for uplink control resources, the transmission of the UE model identifier being via the uplink control resources.

12. A method for wireless communications at a user equipment (UE), comprising:
receiving a request for a UE model identifier from a network entity, the UE model identifier associated with a model from among a plurality of models associated with channel state feedback compression and reporting, the plurality of models corresponding to respective network deployment scenarios and associated UE scenarios and having respective UE model identifiers;
transmitting the UE model identifier in accordance with the request, the UE model identifier associated with a coverage prediction for one or more predicted coverage zones of the UE;
receiving a model identifier from the network entity, the model identifier associated with the UE model identifier and a network model identifier; and
performing channel state feedback compression and reporting according to the model identifier.

13. The method of claim 12, further comprising:
obtaining the plurality of models associated with channel state feedback compression and reporting;
obtaining the coverage prediction for the one or more predicted coverage zones of the UE, the coverage prediction associated with a respective cellular coverage condition for each predicted coverage zone; and
selecting the UE model identifier in accordance with the coverage prediction.

14. The method of claim 12, further comprising:
receiving a message identifying a UE model identifier reporting schedule for the UE, the request for the UE model identifier being in accordance with the message.

15. The method of claim 14, wherein the message comprises at least one of a radio resource control (RRC) message or a downlink control information (DCI) message.

16. The method of claim 12, wherein the respective network deployment scenarios and associated UE scenarios correspond to one or more of a reference signal received power (RSRP), a reference signal received quality (RSRQ), a frequency division duplexing (FDD) configuration, a stand-alone (SA) configuration, a frequency band, a mobility level, an outdoor state, an indoor state, an antenna port configuration, or any combination thereof.

17. The method of claim 12, wherein the coverage prediction is associated with a respective cellular coverage condition for a predicted coverage zone that comprises one or more of a predicted cellular coverage level, a predicted environment type, a predicted UE mobility level, a predicted reference signal received power (RSRP), a predicted signal quality, a predicted frequency band, or a predicted network deployment scenario.

18. The method of claim 12, wherein the coverage prediction is associated with a respective cellular coverage condition for each predicted coverage zone that is determined in accordance with one or more of a reference signal measurement, a radio resource control (RRC) configuration, uplink or downlink grant information, historical information, or any combination thereof.

19. The method of claim 12, further comprising:
selecting a UE assistance information (UAI) framework for transmitting the UE model identifier, the transmission of the UE model identifier being in accordance with the selected UAI framework.

20. An apparatus for wireless communications at a user equipment (UE), comprising:
a processing system that includes one or more processors and one or more memories coupled with the one or more processors, the processing system configured to cause the apparatus to:
obtain a plurality of models associated with channel state feedback (CSF) time domain prediction and reporting or compression and reporting, the plurality of models corresponding to respective network deployment scenarios and associated UE scenarios;
obtain a coverage prediction for one or more predicted coverage zones of the UE, the coverage prediction associated with a respective cellular coverage condition for each predicted coverage zone;
select a model from the plurality of models in accordance with the coverage prediction; and
perform CSF time domain prediction and reporting or compression and reporting according to the model.
